(19) United States
(12) Patent Application Publication
(10) Pub. No.: US 2026/0131904 A1
(43) Pub. Date: May 14, 2026

(54) SYSTEM AND METHOD FOR AUTOMATING TRANSFER OF LUGGAGE WITHIN AN AIRPORT

(71) Applicant: Azalea Robotics Corporation, Athens, GA (US)

(72) Inventors: David Richman Millard, Berkeley, CA (US); John Bradley Stroud, Athens, GA (US); Prabhpreet Singh Dhir, Emeryville, CA (US); Brett Russell Stephens, Lafayette, CA (US)

(21) Appl. No.: 19/388,673

(22) Filed: Nov. 13, 2025

Related U.S. Application Data
(60) Provisional application No. 63/720,018, filed on Nov. 13, 2024.
(60) Provisional application No. 63/846,431, filed on Jul. 18, 2025.

(51) Int. Cl. B64F 1/32; B25J 9/16

(52) U.S. Cl. CPC B64F 1/324; B25J 9/1612; B25J 9/162; B25J 9/163; B25J 9/1653; B25J 9/1679; B25J 9/1697

(57) ABSTRACT

One variation of a system for automating transfer of luggage units within an airport includes: a platform configured to navigate along an autonomous work zone located within an airport luggage bay between a luggage carousel and luggage carts; a robotic arm arranged on the platform; an optical sensor defining a field of view intersecting the luggage carousel; and a controller. The controller is configured to: select a luggage unit, depicted in an image captured by the optical sensor, for retrieval from the luggage carousel; derive a target engagement specification for retrieving the luggage unit based on characteristics of the luggage unit; trigger the robotic arm to engage the luggage unit according to the target engagement specification; trigger the robotic arm to extract the luggage unit from the luggage carousel; and trigger the robotic arm to locate the luggage unit in a luggage cart located within the airport luggage bay.

### CROSS-REFERENCE TO RELATED APPLICATIONS

This Application claims the benefit of U.S. Provisional Application No. 63/846,431, filed on 18 Jul. 2025, and U.S. Provisional Application No. 63/720,018, filed on 13 Nov. 2024, each of which is incorporated in its entirety by this reference.

### TECHNICAL FIELD

This invention relates generally to the field of airport operations and, more specifically, to a new and useful method for automating transfer of luggage within an airport in the field of airport operations.

### BRIEF DESCRIPTION OF THE FIGURES

FIGS. 1A and 1B are schematic representations of a system;

FIG. 2 is a flowchart representation of a method;

FIG. 3 is a flowchart representation of one variation of the method;

FIG. 4 is a flowchart representation of one variation of the method;

FIG. 5 is a flowchart representation of one variation of the method;

FIG. 6 is a flowchart representation of one variation of the method;

FIGS. 7A and 7B are schematic representations of one variation of the system; and

FIGS. 8A-8D are schematic representations of one variation of the system.

### DESCRIPTION OF THE EMBODIMENTS

The following description of embodiments of the invention is not intended to limit the invention to these embodiments but rather to enable a person skilled in the art to make and use this invention. variations, configurations, implementations, example implementations, and examples described herein are optional and are not exclusive to the variations, configurations, implementations, example implementations, and examples they describe. The invention described herein can include any and all permutations of these variations, configurations, implementations, example implementations, and examples.

### 1. System

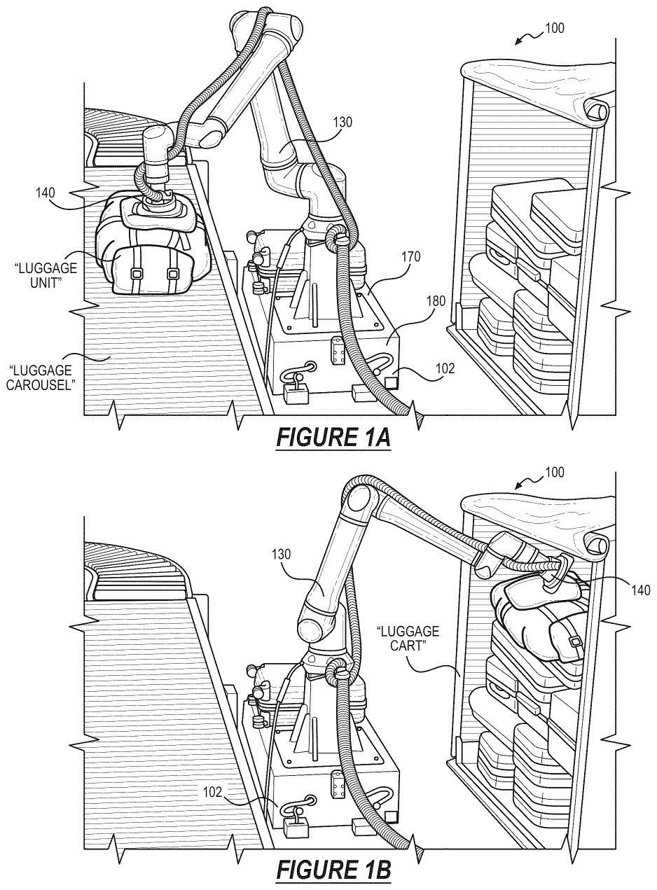

As shown in FIGS. 1-4, 6, 7A, 7B, and 8D, a robotic system 102 configured to autonomously manipulate luggage units within an airport luggage bay includes: a platform 110 configured to navigate along an autonomous work zone located within the airport luggage bay between a luggage carousel conveying luggage units and luggage carts transiently storing luggage units; a robotic arm 130 arranged on the platform 110 and including an end effector 140 configured to manipulate luggage units; an optical sensor 150 defining a field of view intersecting the luggage carousel; and a controller.

The controller 160 is configured to: access an image captured by the optical sensor 150 and depicting luggage units located on the luggage carousel; select a luggage unit, depicted in the image, for retrieval from the luggage carousel, the luggage unit exhibiting a set of luggage characteristics; derive a target engagement specification for the robotic arm 130 to engage the luggage unit based on the set of luggage characteristics; trigger the robotic arm 130 to locate the end effector 140 in a target engagement pose defined in the target engagement specification; trigger the end effector 140 to engage the luggage unit according to the target engagement specification; trigger the robotic arm 130 to extract the luggage unit from the luggage carousel; and trigger the robotic arm 130 to locate the luggage unit in a target storage pose within a luggage cart located within the airport luggage bay.

### 1.1 Variation: Multi-Environment Robotic System

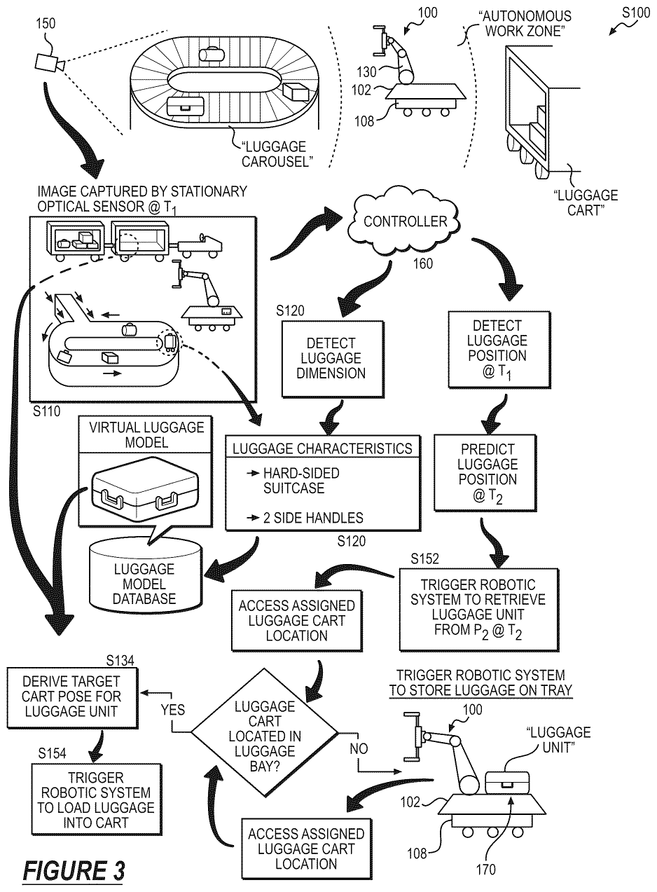

As shown in FIGS. 3, 4, 6, 7A, 7B, and 8D, one variation of the system 100 includes: a platform 110; a robotic arm 130 arranged on the platform 110; and a controller 160.

In this variation, the platform 110 is configured to: navigate between a luggage carousel and luggage carts, located adjacent the luggage carousel within an airport luggage bay, at an airport; and navigate between an aircraft conveyor, conveying luggage units into an aircraft, and luggage carts located adjacent the aircraft conveyor on a tarmac at the airport.

The robotic arm 130 is configured to: transfer luggage units from the luggage carousel to luggage carts located within the airport luggage bay; and transfer luggage units from luggage carts, located on the tarmac, to the aircraft conveyor.

The controller 160 is configured to: detect a first set of luggage characteristics and a first orientation of a luggage unit located on the luggage carousel; derive a first target engagement specification for retrieving the luggage unit from the luggage carousel based on the first set of luggage characteristics and the first orientation of the luggage unit; trigger the platform 110 to locate the robotic arm 130 proximal the luggage unit on the luggage carousel; trigger the robotic arm 130 to extract the luggage unit from the luggage carousel according to the first target engagement specification; and trigger the robotic arm 130 to locate the luggage unit in a target storage pose within a luggage cart located within the airport luggage bay.

### 2. Method

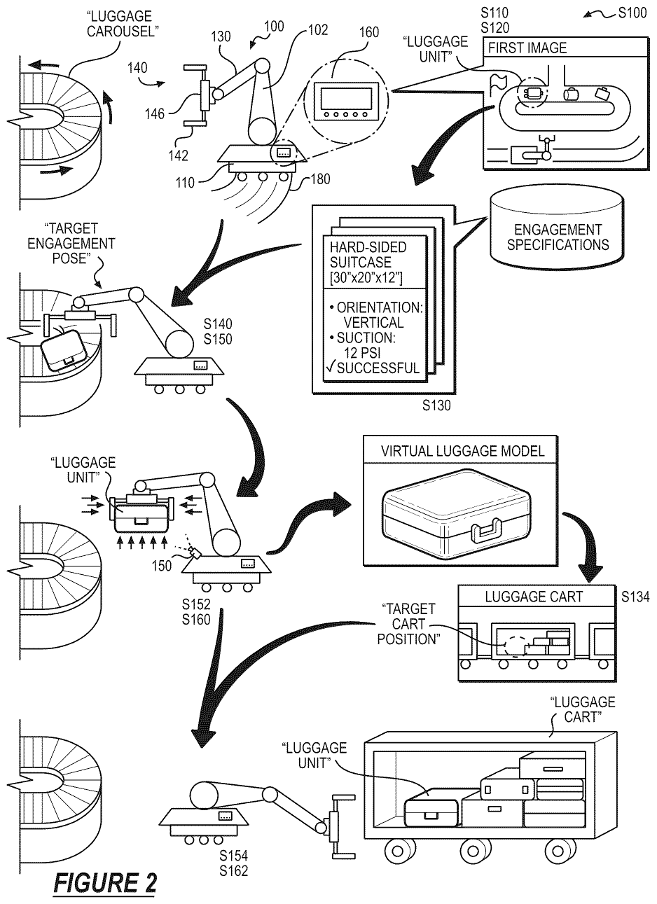

As shown in FIGS. 2-6, a method S100 for automating transfer of luggage units within an airport luggage bay includes: accessing an image captured by an optical sensor 150 defining a field of view intersecting a luggage carousel located within an airport luggage bay, the image depicting luggage units located on the luggage carousel in Block S110; detecting a set of luggage characteristics of a luggage unit, selected for retrieval from the luggage carousel, based on the image in Block S120; and deriving a target engagement specification for retrieval of the luggage unit from the luggage carousel via a robotic system 102 based on the set of luggage characteristics in Block S130.

The method S100 also includes: autonomously navigating a platform 110 of the robotic system 102 to collocate a robotic arm 130, arranged on the platform 110, with the luggage unit in Block S140; maneuvering the robotic arm 130 to locate an end effector 140, arranged on a distal end of the robotic arm 130, in a target engagement pose defined in the target engagement specification in Block S150; triggering the end effector 140 to engage the luggage unit according to the target engagement specification in Block S160; and retracting the robotic arm 130 from the luggage carousel to extract the luggage unit from the luggage carousel in Block S152.

The method S100 further includes: maneuvering the robotic arm 130 to locate the luggage unit in a target storage pose within a luggage cart located within the airport luggage bay in Block S154; and triggering the end effector 140 to disengage (or “release”) the luggage unit in Block S162.

### 2.1 Variation: Robotic System on Conveyor

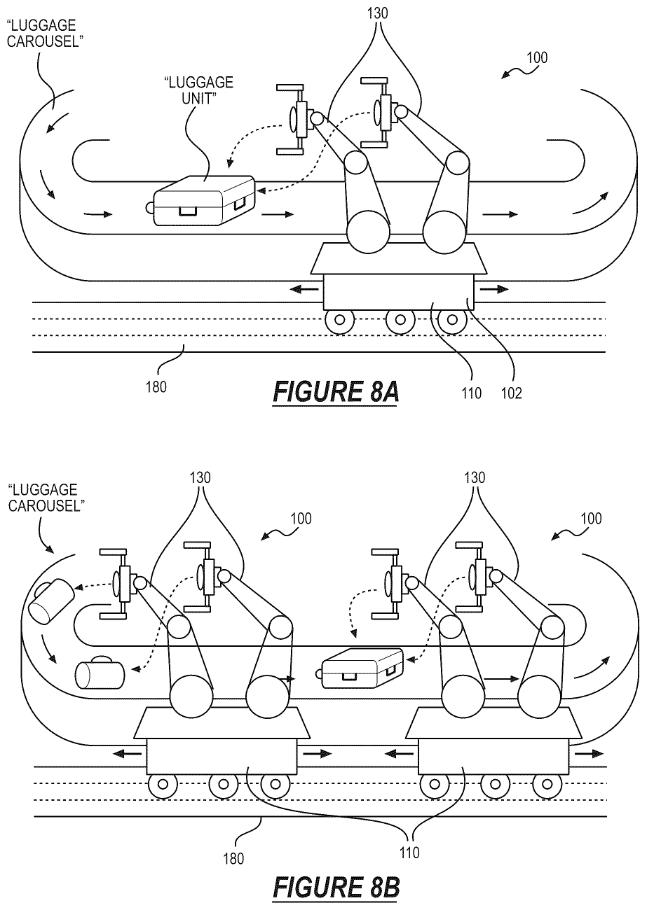

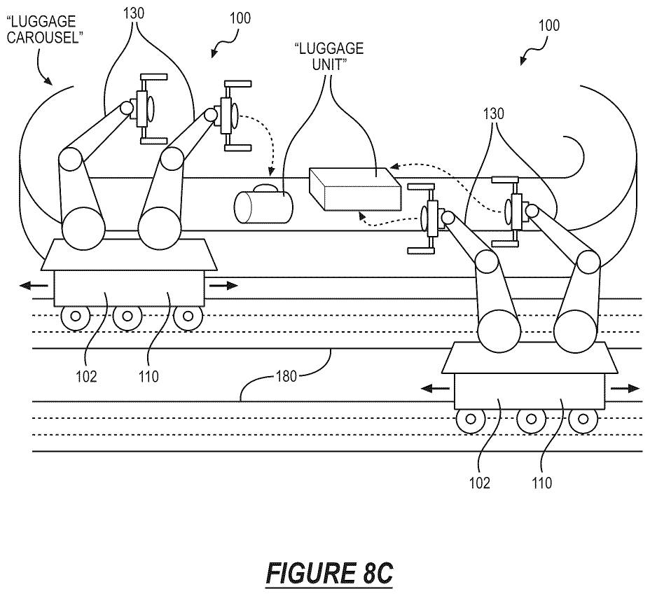

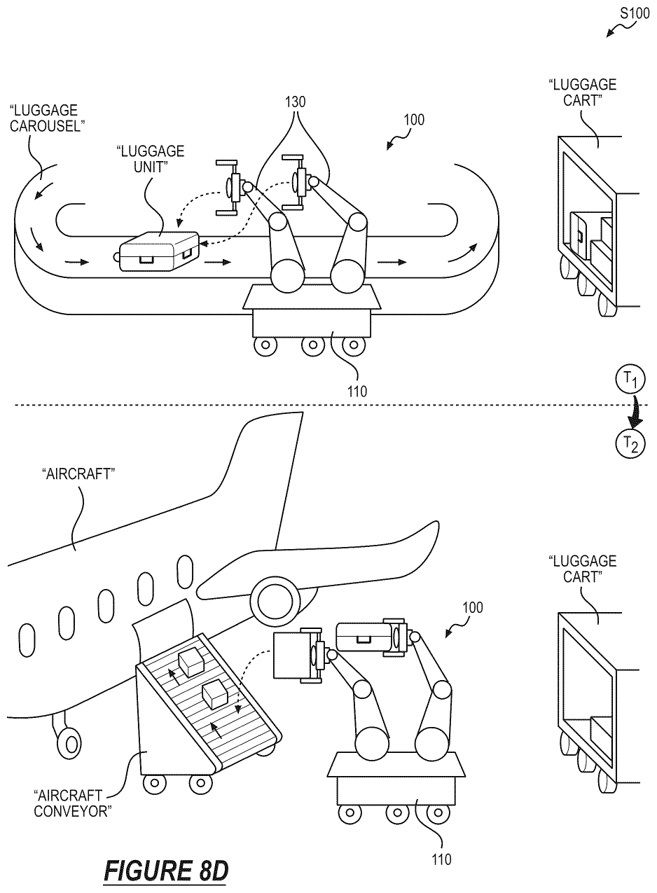

As shown in FIGS. 2 and 8A-8C, one variation of the method S100 for automating transfer of luggage units within an airport luggage bay includes: accessing a first image captured by a first optical sensor 150 arranged proximal a luggage carousel located in the airport luggage bay, the first image depicting a set of luggage units located on the luggage carousel in Block S110; selecting a luggage unit, in the set of luggage units depicted in the first image, for retrieval from the luggage carousel; extracting a set of luggage characteristics of the luggage unit from a region of the first image depicting the luggage unit in Block S120; and deriving a target engagement specification for retrieval of the luggage unit from the luggage carousel by a robotic system 102 based on a) the set of luggage characteristics and b) a gripping model representing engagement specifications associated with successful retrieval of luggage units from luggage carousels by instances of the robotic system 102 in Block S130.

This variation of the method S100 also includes triggering a conveyor 180 of the robotic system 102 to traverse a platform 110 of the robotic system 102 along a work zone of the luggage carousel—to collocate a robotic arm 130, arranged on the platform 110, with the luggage unit—in response to the luggage unit entering the work zone of the luggage carousel.

This variation of the method S100 further includes: triggering the robotic arm 130 to maneuver an end effector 140, coupled to the robotic arm 130, along an engagement path to locate the end effector 140 in a target engagement pose defined in the target engagement specification to engage the luggage unit in Block S150; triggering a vacuum pump coupled to a suction head of the end effector 140 to draw a vacuum at the suction head to transiently retain the luggage unit to the end effector 140 according to the target engagement specification in Block S160; triggering a gripper of the end effector 140 to apply a gripping force to a first side surface and a second side surface of the luggage unit according to the target engagement specification in Block S160; and triggering the robotic arm 130 to maneuver the end effector 140 along a retraction path to extract the luggage unit from the luggage carousel in Block S152.

This variation of the method S100 also includes: triggering a second optical sensor 150, arranged on the platform 110, to record a series of images of the luggage unit; compiling the series of images into a first three-dimensional virtual representation of the luggage unit; accessing a second three-dimensional virtual representation of a target luggage cart located facing the robotic system 102 opposite the luggage carousel and assigned to the luggage unit; based on the first three-dimensional virtual representation and the second three-dimensional virtual representation, deriving a target storage pose for the luggage unit within the target luggage cart in Block S134; triggering the conveyor 180 to traverse the platform 110 to collocate the robotic arm 130 adjacent the target luggage cart; and triggering the robotic arm 130 to maneuver the end effector 140 along a delivery path to locate the luggage unit in the target storage pose in the luggage cart in Block S154.

### 2.2 Variation: Coordinated Dual-Arm Retrieval+Placement of Luggage Units

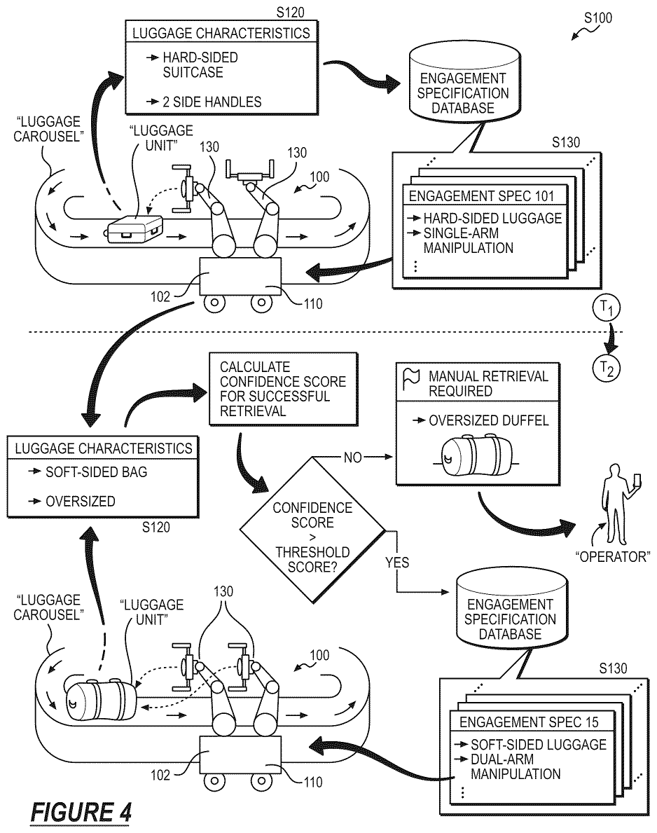

As shown in FIGS. 4 and 8A-8D, one variation of the method S100 includes: accessing a first image captured by an optical sensor 150 arranged proximal a luggage carousel located in the airport luggage bay, the first image depicting luggage units located on the luggage carousel during a first time period in Block S110; interpreting a first set of luggage characteristics of a first luggage unit entering a work zone proximal a robotic system 102 based on the first image in Block S120; and deriving a first target engagement specification for retrieval of the first luggage unit from the luggage carousel, the first target engagement specification specifying coordinated retrieval by a pair of robotic arms 130 of the robotic system 102 based on the first set of luggage characteristics in Block S130.

This variation of the method S100 also includes: triggering a conveyor 180 to traverse the robotic system 102 along the work zone to collocate the pair of robotic arms 130 with the first luggage unit located on the luggage carousel; triggering a first robotic arm 130, in the pair of robotic arms 130, to maneuver a first end effector 140, coupled to the first robotic arm 130, along an engagement path to locate the first end effector 140 in a first target engagement pose defined in the first target engagement specification in Block S150; triggering a second robotic arm 130, in the pair of robotic arms 130, to maneuver a second end effector 140, coupled to the second robotic arm 130, along an engagement path to locate the second end effector 140 in a second target engagement pose defined in the first target engagement specification in Block S150; triggering the first end effector 140 and the second end effector 140 to apply suction forces at surfaces of the first luggage unit according to the first target engagement specification to transiently retain the first luggage unit on the first end effector 140 and the second end effector 140 in Block S160; triggering the first end effector 140 and the second end effector 140 to apply gripping forces to surfaces of the first luggage unit according to the first target engagement specification in Block S160; and triggering the pair of robotic arms 130 to retract and lift the first luggage unit from the luggage carousel in Block S152.

This variation of the method S100 further includes: deriving a first target storage pose for the first luggage unit within a luggage cart assigned to the first luggage unit in Block S134; triggering the conveyor 180 to traverse the robotic system 102 to collocate the pair of robotic arms 130 adjacent the luggage cart; and triggering the pair of robotic arms 130 to locate the first luggage unit in the first target storage pose in the luggage cart in Block S154.

### 2.3 Variation: Independent Parallel Retrieval+Placement of Luggage Units

As shown in FIGS. 4 and 8B-8D, one variation of the method S100 further includes: accessing a second image captured by the optical sensor 150 and depicting luggage units located on the luggage carousel during a second time period in Block S110; interpreting a second set of luggage characteristics of a second luggage unit entering the work zone and a third set of luggage characteristics of a third luggage unit entering the work zone based on the second image in Block S120; and deriving a second target engagement specification for retrieval of the second luggage unit and a third target engagement specification for retrieval of the third luggage unit from the luggage carousel, the second and third target engagement specifications specifying independent retrieval by a robotic arm 130, in the pair of robotic arms 130, based on the second and third sets of luggage characteristics in Block S130.

This variation of the method S100 also includes: triggering the conveyor 180 to traverse the robotic system 102 along the work zone to collocate the first robotic arm 130 with the second luggage unit and the second robotic arm 130 with the third luggage unit; triggering the first end effector 140 to engage the second luggage unit according to the second target engagement specification in Block S160; triggering the first robotic arm 130 to retract and lift the second luggage unit from the luggage carousel in Block S152; triggering the second end effector 140 to engage the third luggage unit according to the third target engagement specification in Block S160; and triggering the second robotic arm 130 to retract and lift the third luggage unit from the luggage carousel in Block S152.

This variation of the method S100 further includes: deriving a second target storage pose for the second luggage unit and a third target storage pose for the third luggage unit within the luggage cart in Block S134; triggering the conveyor 180 to traverse the robotic system 102 to collocate the pair of robotic arms 130 adjacent the luggage cart; triggering the first robotic arm 130 to locate the second luggage unit in the second target storage pose in the luggage cart in Block S154; and triggering the second robotic arm 130 to locate the third luggage unit in the third target storage pose in the luggage cart in Block S154.

### 3. Applications

Generally, Blocks of the method can be executed by a robotic system 102 located in an airport luggage bay (hereinafter a “luggage bay”): to detect incoming luggage units (e.g., suitcases, duffel bags) entering a luggage carousel located in the luggage bay; to select a luggage unit for autonomous retrieval by the robotic system 102; to access a target engagement specification defining a path, pose, and/or retention methods (e.g., suction force, gripping force) executable by the robotic system 102 (e.g., a robotic arm 130 and an end effector 140) to engage, retain, and retrieve the luggage unit from the luggage carousel; to execute the target engagement specification to autonomously extract the luggage unit from the luggage carousel; and to autonomously load the luggage unit into a target luggage cart for subsequent delivery to an aircraft.

In particular, at an airport, luggage units may be checked in at a luggage check-in kiosk upstream of the luggage carousel. An airport luggage routing system (e.g., a series of conveyors) may then automatically navigate these luggage units toward a luggage carousel within a luggage handling area of the airport. The luggage carousel may then cycle the luggage units through an autonomous work zone (i.e., a section of the luggage carousel) arranged adjacent the robotic system 102. The robotic system 102 can then execute Blocks of the method S100 to autonomously retrieve luggage units from this autonomous work zone and to autonomously load these luggage units into luggage carts facing the robotic system 102 opposite the autonomous work zone. Human operators working in a manual work zone (i.e., a different section of the luggage carousel) may manually retrieve select luggage units—such as oversized, unconventional, non-standard, bulky, or other irregularly-shaped luggage—and manually load these luggage units into luggage carts.)

### 3.1 Robotic System

In particular, Blocks of the method can be executed by or in cooperation with a robotic system 102 including: a platform 110; a robotic arm 130 mounted to a platform 110 and outfitted with an end effector 140 configured to engage luggage units; a suite of optical sensors 150 configured to record images of luggage units to identify characteristics of the luggage units for deriving maneuvers (e.g., of the robotic arm 130) and/or delivery positions resulting in no collisions with nearby objects; and a controller 160 (e.g., a local or remote controller 160) configured to process data recorded throughout the system (e.g., by the suite of optical sensors 150) and to define and trigger actions by the platform 110, robotic arm 130, and/or the end effector 140.

### 3.2 Luggage Unit Manipulation

Generally, the robotic system 102 can derive a series of robotic arm 130 paths and end effector 140 poses to engage, retain, and transition a luggage unit from the luggage carousel to a luggage cart—and vice versa—during a luggage transfer cycle. The robotic system 102 can then execute these paths and poses to autonomously move luggage units between the luggage carousel and luggage carts while avoiding collisions between the luggage unit and nearby objects, such as other luggage units on the luggage carousel or in the luggage cart.

In one example, the controller 160 can: access an initial image—depicting luggage units on the luggage carousel—captured by an optical sensor 150 defining a field of view that intersects the luggage carousel; select a luggage unit—entering or within the autonomous work zone—for autonomous retrieval; derive a path to locate the robotic system 102 proximal the luggage unit and the end effector 140 in a target engagement pose based on an expected, future position of the luggage unit and a current position of the robotic system 102; and trigger the platform 110 and the robotic arm 130 to execute the path to retrieve the luggage unit.

Thus, the controller 160 can include optical sensors 150 arranged on the robotic system 102 and/or in the luggage bay: to capture image(s) depicting luggage units prior to interaction with the robotic system 102; to derive a current location of the robotic system 102; to derive a current location of a luggage unit selected for autonomous retrieval; to extract characteristics of the luggage unit from these image(s); to derive a target engagement specification (e.g., end effector 140 orientation, gripping force) predicted to yield a successful retrieval of the luggage unit from the luggage carousel; and to then derive the series of paths for execution by the robotic system 102 (e.g., the platform 110, the robotic arm 130) that avoid collisions with nearby objects. Accordingly, the robotic system 102 can operate within the luggage bay with minimal retrofit to existing infrastructure and without requiring replacement of extant equipment (e.g., luggage carts, luggage carousels, luggage check-in kiosks, aircraft conveyors) or extensive reconfiguration of manual work zones.

Furthermore, the robotic system 102 can supplement manual loading of luggage units: to reduce physical burden on workers (e.g., due to heavy or awkwardly shaped luggage units); to mitigate mishandling and/or damage to luggage units; to increase luggage handling efficiency at the airport, such as by maximizing available luggage cart space during luggage cart loading; and to reduce luggage-related delays at the airport, such as luggage misplacement and/or dropped luggage units.

### 3.3 Target Engagement Specifications for Luggage Unit Retrieval

In one application, the robotic system 102 can autonomously: access an upstream image depicting the luggage unit on the luggage carousel (e.g., captured by an optical sensor 150 proximal the luggage carousel); extract characteristics of the luggage unit from the upstream image (e.g., volume, luggage type, maximum dimensions, shape); interpret an orientation of the luggage unit on the luggage carousel from the upstream image; derive an engagement specification based on these luggage unit characteristics and orientation data; and navigate the robotic arm 130 to autonomously extract the luggage unit from the luggage carousel.

In one example, the robotic system 102: stores template engagement specifications—defining engagement orientations, approach paths, and suction forces, etc. and labeled with luggage unit characteristics and an orientation on the luggage carousel—for each successful past luggage unit retrieval; implements template matching techniques to find a template engagement specification labeled with characteristics and an orientation nearest the luggage unit selected for retrieval from the luggage carousel; and then loads and executes this template engagement specification to autonomously extract the luggage unit from the luggage carousel.

In one example, the robotic system 102: stores luggage unit characteristics and an orientation on the luggage carousel as a multi-dimensional vector associated with an engagement specification—defining an engagement orientation, approach path, and suction force, etc.—for each successful past luggage unit retrieval; implements nearest neighbor techniques to find a nearest engagement specification associated with a nearest multi-dimensional vector containing characteristics and an orientation nearest the luggage unit selected for retrieval from the luggage carousel; and then loads and executes this nearest engagement specification to autonomously extract the luggage unit from the luggage carousel.

In another example, the robotic system 102: stores completed (or executed) engagement specifications—defining engagement orientations, approach paths, and suction forces, etc. and labeled with luggage unit characteristics, an orientation on the luggage carousel, and success scores (e.g., 0 for failure, 1 for success, 0.5 if attempted twice with second instance successful)—for each past luggage unit retrieval; implements artificial intelligence, machine learning, and/or regression techniques to train a model based on these historic engagement specifications; and then loads the luggage unit characteristics and orientation of the luggage unit selected for retrieval into the model. In this example, the model returns an engagement specification for the luggage unit, and the robotic system 102 then loads and executes this engagement specification to autonomously extract the luggage unit from the luggage carousel.

Furthermore, the robotic system 102 can access or capture additional (higher-resolution) images of the luggage unit (e.g., via an optical sensor 150 arranged on the robotic arm 130) as the robotic arm 130 navigates the end effector 140 toward the luggage unit according to the engagement specification. Then, if a first attempt to engage the luggage unit fails (e.g., the bag drops), the robotic system 102 can: re-extract characteristics of the luggage unit from these images; implement methods and techniques described above to derive a new engagement specification; and then load and execute this new engagement specification to reattempt autonomous extraction of the luggage unit from the luggage carousel.

### 3.4 Luggage Cart Loading

In one application, the robotic system 102 can: identify a target luggage cart for loading a particular luggage unit; retrieve a three-dimensional virtual representation of the target luggage cart (i.e., the most-recent representation of the luggage cart); calculate a target storage pose (i.e., a stable final position)—on top of other luggage units—for the particular luggage unit; calculate a delivery path to insert and release the luggage unit into the target luggage cart in this target storage pose; and then autonomously execute this delivery path to locate the luggage unit in the target luggage cart.

In particular, the robotic system 102 can detect characteristics of the luggage unit and the three-dimensional virtual representation of the target luggage cart to calculate the target luggage pose in order to: increase stability of luggage units within the cart—and thus reduce risk of luggage spillage from the target luggage cart; reduce damage to the luggage unit when loaded into, transported via, and unloaded from the target luggage cart; and increase packing efficiency of the target luggage cart and thus reduce the quantity of trips required for the target luggage cart to transport luggage units from the luggage carousel to an aircraft.

### 3.5 Three-Dimensional Luggage Unit Record

In one application, once the robotic arm 130 engages and retrieves the luggage unit from the luggage carousel, the controller 160: triggers the robotic arm 130 to traverse the luggage unit past an optical sensor 150 (e.g., arranged on the robotic system 102); accesses an image captured by the optical sensor 150 captures; and detects the luggage type (e.g., hard-sided suitcase) of the luggage unit based on the image.

For example, the controller 160 can: trigger the optical sensor 150 to capture a series of photographic images, stereoscopic images, and/or depth maps; compile these images into a three-dimensional virtual representation of the luggage unit (e.g., prior to loading the luggage unit into a luggage cart); and store the three-dimensional virtual representation in a database.

The controller 160 can then derive a target storage pose for the luggage unit, such as an unoccupied volume within the luggage cart compatible with the luggage type (e.g., hard-sided suitcase, duffel bag), geometry, and dimensions (e.g., volume) of the luggage unit based on this three-dimensional virtual representation of the luggage unit. Additionally or alternatively, the controller 160 can retrieve this three-dimensional virtual representation of the luggage unit—labeled with a time and location of this interaction with the robotic system 102—responsive to a query from an operator (e.g., airport personnel) to verify a luggage damage claim submitted by a customer.

### 3.6 Dual-Arm Coordination for Luggage Transfer

In one variation, the robotic system 102 includes a pair of robotic arms 130 configured to cooperate in sequential or simultaneous manipulation of a luggage unit during execution of the luggage transfer cycle. In particular, the controller 160 can: detect a luggage unit exhibiting a characteristic (e.g., excessive size, deformability, non-uniform shape, irregular orientation) incompatible with efficient single-arm manipulation; and, in response, select a dual-arm manipulation mode for coordinated handling of the luggage unit. In this variation, the controller 160 can interpret, based on a target engagement specification derived from characteristics of the luggage unit, that cooperative simultaneous engagement of multiple robotic arms 130 is required to transport the luggage unit. The controller 160 can then: derive a first engagement pose for a first end effector 140 and a second engagement pose for a second end effector 140; execute respective maneuvering paths for each robotic arm 130; and trigger each end effector 140 to engage the luggage unit at distinct surfaces (e.g., top and side) according to the target engagement specification. Upon successful retention of the luggage unit by the end effectors 140, the robotic system 102 can: retract both robotic arms 130 to lift the luggage unit from the luggage carousel; and execute coordinated delivery paths for both robotic arms 130 to position and release the luggage unit into the cart.

### 3.7 Dual-Arm Coordination Modes

In another variation, the robotic system 102 can execute a sequential manipulation mode that transitions control of the luggage unit between the first and second robotic arms 130, such as to accommodate workspace constraints or non-uniform luggage geometry. In this variation, the controller 160 can trigger the first robotic arm 130 to: retrieve the luggage unit from the luggage carousel; and maneuver the luggage unit to an intermediate position accessible to the second robotic arm 130. The controller 160 can then trigger the second robotic arm 130 to: engage the luggage unit at the intermediate position; and complete transfer of the luggage unit into the luggage cart. Accordingly, the robotic system 102 can execute multiple cooperative manipulation modes, including: sequential transfer between robotic arms 130 (e.g., for complex orientations or workspace limitations); and simultaneous dual-end-effector engagement for additional support or control over a large or unstable luggage unit.

In yet another variation, the robotic system 102 can operate the pair of robotic arms 130 independently to increase throughput, such as during high-traffic periods or when manipulating conventional luggage units of standard geometry. In this variation, each robotic arm 130 can: retrieve an assigned luggage unit from the carousel; and deliver the luggage unit into a target pose within a luggage cart.

Additionally, the robotic system 102 can dynamically toggle between single-arm and dual-arm engagement modes based on real-time evaluation of: luggage characteristics interpreted from optical sensor 150 data (e.g., volume, aspect ratio, deformability indicators); spatial constraints of the luggage carousel and luggage cart; and prior engagement outcomes for similar luggage units (e.g., success/failure scores associated with single-arm attempts).

Accordingly, the robotic system 102 can maximize throughput by selecting an efficient manipulation mode for each luggage unit that: minimizes total transfer time; reduces likelihood of accidental drops or failed retrievals; and prevents structural damage to luggage units. In particular, the robotic system 102 may detect luggage units that are difficult to engage with a single end effector 140 (e.g., large duffel bags, soft-sided suitcases, or top-heavy containers) and select a dual-arm engagement mode to support stable lifting and placement of the luggage unit. More specifically, the robotic system 102 can simultaneously trigger the first and second robotic arms 130 to: engage the luggage unit from multiple surfaces; lift the luggage unit while maintaining engagement between the luggage unit and the end effectors 140; and deliver the luggage unit into a target position within the luggage cart. Alternatively, the robotic system 102 may detect conventional luggage units compatible with single-arm handling (e.g., hard-sided cases of standard dimensions) and operate each robotic arm 130 independently to manipulate and transfer separate luggage units in parallel (i.e., to maximize throughput). By toggling between cooperative and independent dual-arm manipulation modes, the robotic system 102 can adapt to heterogeneous luggage types and operational conditions to maintain high throughput and low error rates across the luggage transfer cycle.

### 3.8 Autonomous Luggage Transfer System

In one variation, the robotic system 102 includes a pair of robotic arms 130 arranged on a platform 110, the platform 110 traversed by a conveyor 180 (i.e., an entirety of the conveyor 180). In another variation, an autonomous luggage transfer system can include a set of (i.e., two or more) robotic systems 100 (e.g., including one or more robotic arms 130) configured to traverse a section (i.e., a non-overlapping portion of the conveyor 180 path) of a conveyor 180. In another variation, the autonomous luggage transfer system can include: a first robotic system 102 including a first pair of robotic arms 130 arranged on a first platform 110, the first platform 110 traversed by a first conveyor 180; and a second robotic system 102 including a second pair of robotic arms 130 arranged on a second platform 110, the second platform 110 traversed by a second conveyor 180 located adjacent and parallel to the first conveyor 180. In yet another variation, the autonomous luggage transfer system can include a robotic system 102 including a pair of robotic arms 130 arranged on an autonomous mobile base 108, wherein the autonomous mobile base 108 is configured to autonomously navigate between distinct zones within the airport luggage bay (e.g., from a luggage carousel area to an aircraft loading zone).

Accordingly, the robotic system 102 can include multiple robotic arms 130 arranged on a common platform 110 and configured to cooperate during luggage retrieval and transfer operations. In one example, the pair of robotic arms 130 can independently retrieve and stow separate luggage units, thereby approximately doubling throughput per unit area occupied by the system 100. In another example, the pair of robotic arms 130 can jointly manipulate a single luggage unit—such as a heavy, oversized, or irregularly shaped item—to increase the baggage load-carrying capacity of the system 100 and reduce the likelihood of accidental drops. In particular, the controller 160 can coordinate dual-arm manipulation for luggage units identified as higher risk of slippage or deformation (e.g., soft-sided, under-filled bags of uncertain geometry).

More specifically, each robotic arm 130 can exhibit relatively small form-factor characteristics—such as lower mass, shorter reach, and lower operational velocity—thereby reducing occupational hazards to human personnel operating near the system 100. For example, the robotic arms 130 can include collaborative robots (cobots) configured for uncaged operation in shared workspaces rather than industrial robotic arms requiring physical barriers. In particular, the reduced payload capacity and reach of individual robotic arms 130 can limit the range of luggage types handled by a single arm; however, these coordinated arms of similar scale can expand the range of manipulable luggage units. More specifically, the pair of robotic arms 130 can cooperatively engage and lift heavy, elongated, oblong, unevenly weighted, or deformable soft-sided luggage units without substantially increasing risk to human personnel operating near the system 100.

### 3.9 Multi-Zone Autonomous Luggage Transfer

Furthermore, the robotic system 102 and the method S100 are generally described herein to autonomously transfer luggage units from a luggage carousel into a luggage cart. However, the robotic system 102 can implement similar methods and techniques: to autonomously transfer luggage units from a luggage cart onto a luggage carousel, such as for distribution to a downstream luggage-claim carousel; to autonomously transfer luggage units from a luggage cart onto an aircraft conveyor configured to load luggage units into a storage region of an outbound aircraft; and/or autonomously transfer luggage units from an aircraft conveyor (e.g., stored in the storage region of an inbound aircraft) into a luggage cart.

### 3.10 Autonomous Luggage Transfer Systems

Generally, the robotic system 102 and the method S100 are described herein as including a single robotic arm 130 mounted to an autonomous mobile base 108 configured to navigate along the luggage carousel and the tarmac. However, the robotic system 102 can include multiple robotic arms 130 and/or alternative mounting configurations to accommodate different operational zones within the airport luggage bay.

In one variation, the robotic system 102 can include a pair of robotic arms 130 arranged on an autonomous mobile base 108 and configured to perform coordinated or independent luggage retrieval and transfer operations. In another variation, one or more robotic arms 130 can be arranged on a platform 110 traversed by a conveyor 180 adjacent the luggage carousel, such as to perform continuous or sequential retrieval of luggage units.

In another variation, the robotic system 102 can include one or more robotic arms 130 (e.g., industrial robotic arms) arranged on platform 110 traversed by a conveyor 180 or on an autonomous mobile base 108 arranged within a caged area surrounding a section of the luggage carousel.

### 4. Robotic System

Generally, as shown in FIGS. 1A and 1B, the robotic system 102 includes: a platform 110 configured to navigate along an autonomous work zone located within an airport luggage bay between a luggage carousel conveying luggage units and luggage carts transiently storing luggage units; a set of (i.e., one or more) robotic arms 130 arranged on the platform 110, each robotic arm 130 including an end effector 140 configured to engage and retain luggage units (e.g., via a mechanical gripper and/or a suction gripper); a set of (i.e., one or more) optical sensors 150; and a controller 160 configured to execute Blocks of the method S100 to trigger the robotic system 102 to engage, retain, and transfer luggage units between the luggage carousel, luggage carts located within the airport luggage bay, and aircraft conveyors.

In particular, the robotic system 102 is located within the airport luggage bay (or “luggage bay”) and configured: to load luggage units from the luggage carousel (e.g., a revolving carousel arranged downstream of a luggage check-in kiosk) into luggage carts for delivery to an aircraft; to unload luggage units from luggage carts onto the luggage carousel for dispersion to a luggage claim facility within an airport; to load luggage units from luggage carts onto an aircraft conveyor (e.g., of an outbound aircraft); and to load luggage units from an aircraft conveyor (e.g., of an inbound aircraft) into luggage carts for delivery to the luggage carousel.

### 4.1 Platform

In one implementation, the robotic system 102 includes a platform 110 configured to navigate along the autonomous work zone, such as to locate the robotic arm 130 proximal a luggage unit selected for retrieval.

In one implementation, the robotic system 102 includes a platform 110: supporting the robotic arm 130; configured to maneuver the robotic arm 130; and thus cooperating with the robotic arm 130 to retrieve, transport, and deliver luggage units between spatially distributed locations within the airport luggage bay (e.g., without reliance on a fixed conveyor infrastructure). The platform 110 is weighted to counterbalance a load applied by the robotic arm 130 when extended from the platform while retaining luggage units.

In another implementation, the robotic system 102 can include: an autonomous mobile base 108 (e.g., a platform 110) configured to autonomously navigate the facility; and a pair of robotic arms 130 arranged on the autonomous mobile base 108 and configured to cooperate to retrieve and transport luggage units. In particular, the autonomous mobile base 108 can include: a set of drive motors configured to drive the autonomous mobile base 108; and a set of depth sensors configured to detect objects proximal the robotic system 102.

In this implementation, the robotic system 102 can: navigate the pair of robotic arms 130 a first position—adjacent the luggage carousel—via the autonomous mobile base 108; retrieve a luggage unit via the pair of robotic arms 130; navigate to a second position—adjacent a luggage cart—via the autonomous mobile base 108; stow the luggage unit in the luggage cart via the pair of robotic arms 130; and navigate to a third position—proximal an aircraft conveyor—to support luggage transfer to or from the aircraft.

### 4.1.1 Variation: Conveyor

In one variation, the platform 110 can be arranged on a conveyor 180—located within the luggage bay—and traversed by the conveyor 180. In particular, the conveyor 180 can be interposed between and extend along a section of the luggage carousel and the autonomous loading zone. For example, the conveyor 180 can include a fixed or rigidly-mounted conveyor (e.g., mounted to a ground surface of the luggage bay) configured to traverse the platform 110 linearly along (all or a portion of) a length of the autonomous loading zone. The platform 110 can be configured to navigate along the conveyor 180 to reach and reliably engage luggage units along the full length of the autonomous loading zone.

### 4.2 Robotic Arms

In one implementation, the robotic system 102 can include a robotic arm 130 (e.g., a multi-segment robotic arm 130) arranged on the platform 110. The robotic arm 130 can include an end effector 140 coupled to a distal end of the robotic arm 130. The robotic arm 130 can define a set of (i.e., one or more) joints configured to articulate across multiple degrees of freedom to reach, grasp, and manipulate luggage units located at various positions relative to the platform 110. In particular, the robotic arm 103 (e.g., a cobot arm) is configured to: extend from the platform 110 in a first direction to locate the end effector 140 proximal the luggage carousel; extend from the platform 110 in a second direction, different from the first direction, to locate the end effector 140 proximal the luggage cart; and operate at a maximum velocity less than a threshold velocity (e.g., 250 mm/s when uncaged) defined for operation proximal a manual work zone; and retain luggage units exhibiting masses less than a luggage mass threshold (e.g., 50 pounds).

In one variation, as shown in FIGS. 4 and 8A-8D, the robotic system 102 can include a pair of robotic arms 130 (e.g., multi-segment robotic arms 130) arranged on the platform 110. For example, the robotic system 102 can include: a first robotic arm 130 (e.g., a picking arm) including a first end effector 140 (e.g., a suction head and/or a gripper) configured to retrieve a luggage unit from the luggage carousel and transfer this luggage unit to a second robotic arm 130; and the second robotic arm 130 (e.g., a placing arm) including a second end effector 140 (e.g., a suction head and/or a gripper) configured to receive the luggage unit from the first robotic arm 130 and place the luggage unit within a luggage cart. In another example, the robotic system 102 can include a pair of robotic arms 130, each robotic arm 130 including a similar end effector 140 configured to retrieve a luggage unit from the luggage carousel and transfer the luggage unit to a luggage cart.

Thus, in this variation, the pair of robotic arms 130 can be configured to: cooperate to simultaneously grasp and stabilize a particular luggage unit (e.g., oversized, irregular, or deformable luggage units) during retrieval or placement, such that both arms engage the same luggage unit to distribute the load or maintain orientation; execute a sequential manipulation of the luggage unit by transitioning control of the luggage unit between the first and second robotic arms 130; and/or operate in parallel to independently simultaneously retrieve and transfer separate luggage units from the luggage carousel to the luggage cart (i.e., to increase throughput).

### 4.3 End Effector

The end effector 140 can be arranged on a distal end of the robotic arm 130 and configured to manipulate luggage units.

In one example, the end effector 140 can include a gripper configured to grasp the sides and/or edges of the luggage unit. In particular, each gripper can be coupled to a retractable ram interposed between the gripper and the end effector 140, orthogonal to the gripper, and configured to retract inwardly toward a center of the end effector 140 to apply a gripping force to the sides and/or edges of the luggage unit. Each gripper can be configured to transiently rotate to a retracted position parallel to the ram, as discussed in detail below.

In another example, the end effector 140 can include: a suction head configured to engage (e.g., apply a suction force to) a side of the luggage unit. In particular, the end effector 140 can cooperate with a vacuum pump configured to draw a vacuum at the suction head to transiently retain the luggage unit to the end effector 140.

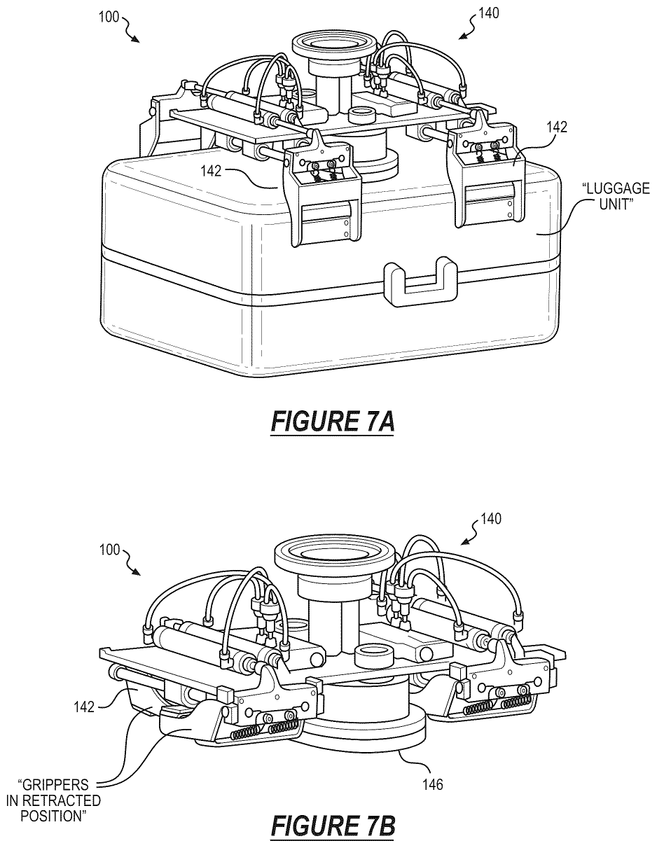

In another example, as shown in FIGS. 7A and 7B, the end effector 140 can include the gripper and a suction head. In this example, the end effector 140 can simultaneously apply a gripping force to the sides and/or edges of the luggage unit while drawing a vacuum at the suction head to transiently retain the luggage unit to the end effector 140.

### 4.4 Sensors

Furthermore, the robotic system 102 can include a suite of optical sensors 150, such as stereoscopic sensors, color cameras, LIDAR sensors, depth sensors, two-dimensional cameras, and/or three-dimensional cameras. In particular, the suite of optical sensors 150 can include onboard sensors arranged on the robotic system 102 and/or external sensors arranged throughout the airport (e.g., within the luggage bay). More specifically, each optical sensor 150 can be configured to capture images depicting surfaces and objects (e.g., a luggage carousel, a luggage cart, luggage units, human operators) within the field of view of the optical sensor 150. The robotic system 102 can then access these images, such as: to generate a virtual map of the luggage bay that represents positions of objects (e.g., the luggage carousel, luggage carts) within the luggage bay; and/or to detect and select luggage units for retrieval from the luggage carousel.

### 4.4.1 Platform Optical Sensor

In one implementation, the suite of optical sensors 150 can include an optical sensor 150 arranged on the platform 110, such as a color camera, a stereoscope camera, or a depth sensor. The optical sensor 150 can: define a field of view intersecting a path of the end effector 140 between the luggage carousel and an adjacent luggage cart; and be configured to capture images of a luggage unit retained by the end effector 140, such as during transfer from the luggage carousel to the luggage cart. In particular, the optical sensor 150 can be configured to capture images of surfaces and objects proximal the robotic system 102 as the robotic system 102 navigates through the luggage bay. In one example, the optical sensor 150 can: capture a first image at a first time that depicts a luggage unit entering the autonomous work zone and a set of luggage characteristics of the luggage unit; and capture a second image at a second time that depicts unoccupied volumes within the luggage cart for stowing luggage units.

### 4.4.2 Stationary Optical Sensor

Additionally or alternatively, the robotic system 102 can cooperate with optical sensors 150 (e.g., a color camera, a stereoscope camera) arranged in the luggage bay, such as to capture images of luggage units entering and revolving around the luggage carousel. In one implementation, the suite of optical sensors 150 can include an optical sensor 150 (e.g., a stationary optical sensor 150) located at a fixed location within the luggage bay, such as proximal an inlet of the luggage carousel, or arranged over the luggage carousel. In particular, the optical sensor 150 can define a field of view intersecting the autonomous work zone, the luggage carousel and/or one or more luggage carts located in the luggage bay. For example, the optical sensor 150 can be configured to capture images depicting both the luggage carousel and interior volumes of luggage carts within a single image frame. In one example, the robotic system 102 can include or interface with an optical sensor 150: arranged in the luggage bay at an inlet of the luggage carousel; defining a field of view of the inlet of the luggage carousel; and configured to capture images of incoming luggage units entering the luggage carousel.

### 4.4.3 Robotic Arm Optical Sensor

In one variation, the suite of optical sensors 150 can include an optical sensor 150: arranged on the robotic arm 130 (e.g., proximal a joint of the robotic arm 130, on the end effector 140); defining a field of view extending outwardly from the robotic arm 130; and configured to capture images (e.g., two-dimensional color images, stereoscopic color images, depth maps) depicting objects and surfaces proximal the robotic system 102. For example, the robotic system 102 can include an optical sensor 150: arranged on the end effector 140; and configured to capture images depicting surfaces of luggage units approached by the end effector 140.

### 4.4.4 Luggage Bay Map+Robotic System Localization

In one implementation in which the robotic system 102 includes an optical sensor 150 (e.g., a stationary optical sensor 150) located at a fixed location (e.g., proximal an inlet of the luggage carousel, or arranged over the luggage carousel) within the luggage bay, the controller 160 can compile images—captured by the optical sensor 150—into a virtual map of the luggage bay that represents spatial positions of static infrastructure (e.g., conveyors, carts, carousels) and dynamic objects (e.g., luggage units). The controller 160 can then: access an image captured by an optical sensor 150 (e.g., a LIDAR sensor, a stereoscopic sensor)—arranged on the robotic system 102—and depicting surfaces and objects proximal the robotic system 102; and derive a position of the robotic system 102—within the luggage bay—such as by matching detected features of carts, conveyors, or carousels—depicted in the image—against corresponding features in the virtual map. Furthermore, the controller 160 can: detect positions of luggage units on the luggage carousel based on the virtual map; and trigger actions by the robotic system 102 (e.g., the platform 110, the end effector 140) based on these known positions of the robotic system 102 and luggage units.

### 4.5 Controller

Generally, the controller 160 is configured to access images captured by one or more optical sensors 150 arranged throughout the system—including stationary optical sensors 150 located overhead in the luggage bay, optical sensors 150 arranged on the robotic arm 130, and/or optical sensors 150 integrated within or adjacent the end effector 140. The controller 160 processes these images to detect luggage units, determine positional relationships between the luggage units and the robotic system 100, and define a sequence of actions for the platform 110, the robotic arm 130, the end effector 140, and/or the conveyor 180 to execute. In particular, the controller 160 can: detect a luggage unit entering the autonomous work zone within the airport luggage bay; derive a target engagement specification for retrieving the luggage unit from the luggage carousel based on a set of luggage characteristics of the luggage unit; trigger the platform 110 to locate the robotic arm 130 proximal the luggage unit; trigger the robotic arm 130 to extract the luggage unit from the luggage carousel via the end effector 140; and trigger the robotic arm 130 to locate the luggage unit in a target storage pose within a luggage cart located within the airport luggage bay.

In one implementation, the controller 160 can access a single image depicting the luggage carousel and the robotic system 100. In this implementation, the controller 160 can: access an image captured by an overhead optical sensor 150; detect luggage units and a current position of the end effector 140 within the image; select a luggage unit for retrieval; extract a set of luggage characteristics (e.g., dimensions, rigidity, side-surface profile) of the luggage unit from the image; and derive a target engagement specification for the end effector 140 based on the extracted luggage characteristics. The controller 160 can then estimate a future time and a corresponding future position of the luggage unit based on the current conveyor velocity and the current relative positions of the luggage unit and the end effector 140. The controller 160 can trigger the robotic arm 130 to navigate the end effector 140 toward the predicted future position and target engagement pose, thereby coordinating interception of the moving luggage unit.

Alternatively, the controller 160 can derive the engagement path by iteratively processing a series of images depicting the luggage carousel over a particular time window. In this implementation, the controller 160 can: calculate a current positional difference between the end effector 140 and the luggage unit; trigger the robotic arm 130 to navigate the end effector 140 toward the target luggage unit to reduce the positional difference; and iteratively repeat this process for successive images until the end effector 140 engages the luggage unit. By iteratively accessing a series of images captured by the optical sensor 150, the robotic system 102 can accommodate variable conveyor speeds or dynamic luggage movement, such as shifting or rotation of luggage units during transport.

Additionally or alternatively, the controller 160 can combine image data captured from multiple optical sensors 150 to coordinate retrieval of luggage units. For example, the controller 160 can: access images captured by one or more optical sensors 150 (e.g., overhead optical sensor) to detect and identify luggage units entering the autonomous work zone; and access images captured by an optical sensor 150, arranged on the robotic system 102, to refine positional alignment of the end effector 140 during engagement.

The controller 160 can implement similar image-based methods and techniques to execute luggage placement. In particular, the controller 160 can: access one or more images captured by these optical sensors 150 and depicting interior volumes of a luggage cart; detect unoccupied volumes within the luggage cart; and derive a target storage pose for the luggage unit within the luggage cart based on these detected volumes.

In one implementation, the controller 160 can: access an image captured by an optical sensor 150 (e.g., a stationary overhead optical sensor) depicting luggage units located on the luggage carousel; select a luggage unit, depicted in the image, for retrieval from the luggage carousel; derive a target engagement specification for the robotic arm 130 to engage the luggage unit based on a set of detected luggage characteristics; trigger the robotic arm 130 to locate the end effector 140 in a target engagement pose defined in the target engagement specification; trigger the end effector 140 to engage the luggage unit; trigger the robotic arm 130 to extract the luggage unit from the luggage carousel; and trigger the robotic arm 130 to locate the luggage unit in a target storage pose within a luggage cart located within the airport luggage bay.

### 5. Luggage Transfer From Luggage Carousel to Luggage Cart

Generally, as shown in FIG. 2, the robotic system 102 can: retrieve luggage units from a section of the luggage carousel proximal the autonomous loading zone (or a “work zone”); and load the luggage units into luggage carts arranged in the autonomous loading zone for delivery to an outbound aircraft, such as via a luggage delivery vehicle coupled to a sequence of luggage carts.

In one implementation, the controller 160 can: access an image captured by an optical sensor 150 defining a field of view intersecting a luggage carousel located within an airport luggage bay, the image depicting luggage units located on the luggage carousel; detect a set of luggage characteristics of a luggage unit, selected for retrieval from the luggage carousel, based on the image; and derive a target engagement specification for retrieval of the luggage unit from the luggage carousel via the robotic system 102 based on the set of luggage characteristics. For example, the target engagement specification can specify: a target engagement position and a target orientation for the end effector 140; a target engagement surface on the luggage unit; a target gripping force for gripping the luggage unit; and/or single-arm or dual-arm manipulation.

The robotic system 102 can then: autonomously navigate the platform 110 to collocate the robotic arm 130, arranged on the platform 110, with the luggage unit; maneuver the robotic arm 130 to locate an end effector 140, arranged on a distal end of the robotic arm 130, in a target engagement pose defined in the target engagement specification; and trigger the end effector 140 to engage the luggage unit according to the target engagement specification. In response to detecting successful engagement between the end effector 140 and the luggage unit, the robotic system 102 can: retract the robotic arm 130 from the luggage carousel to extract the luggage unit from the luggage carousel; maneuver the robotic arm 130 to locate the luggage unit in a target storage pose within a luggage cart located within the airport luggage bay; and trigger the end effector 140 to disengage the luggage unit.

Accordingly, the robotic system 102 can autonomously: select a luggage unit to retrieve from the luggage carousel; derive a target engagement specification predicted to result in successful retrieval of the luggage unit when implemented by the robotic system 102; execute the target engagement specification to extract the luggage unit from the luggage carousel; and position the luggage unit within a luggage cart configured to transiently stow the luggage unit during delivery to an outbound aircraft assigned to the luggage unit.

### 5.1 Luggage Selection

Blocks of the method S100 recite: accessing an image captured by an optical sensor 150 defining a field of view intersecting a luggage carousel located within an airport luggage bay, the image depicting luggage units located on the luggage carousel in Block S110; and detecting a set of luggage characteristics of a luggage unit, selected for retrieval from the luggage carousel, based on the image in Block S120. Generally, in Block S120, the controller 160 can detect luggage units—located on the luggage carousel—entering the work zone and detect characteristics of these luggage units based on images captured by an optical sensor 150 (e.g., arranged within the luggage bay, arranged on the platform 110).

In one implementation, the controller 160 can: access an image (e.g., captured by an optical sensor 150 arranged proximal the luggage carousel) depicting a set of luggage units entering the work zone; select a luggage unit—depicted in the image—for autonomous retrieval from the luggage carousel; and extract a set of luggage characteristics of the luggage unit from the image. For example, the controller 160 can detect luggage characteristics, such as: a luggage type of the luggage unit (e.g., soft-sided suitcase, hard-sided suitcase, duffel bag, backpack); a geometry of the luggage unit (e.g., a quantity of side surfaces); a material of the luggage unit; a dimension of the luggage unit (e.g., length, depth, width, volume); and/or presence of luggage features such as handles, wheels, bag tags etc. Additionally, based on the image, the controller 160 can detect an orientation of the luggage unit (e.g., accessible sides, angle relative to the platform 110) on the luggage carousel.

### 5.2 Target Engagement Specification

Block S130 of the method S100 recites deriving a target engagement specification for retrieval of a luggage unit from the luggage carousel via the robotic system 102 based on a set of luggage characteristics of the luggage unit. Generally, the controller 160 can: detect luggage units—located on the luggage carousel—entering the work zone in Block S120; select a luggage unit for autonomous retrieval; and derive a target engagement specification for the end effector 140 to engage the luggage unit in Block S130.

For example, the target engagement specification can specify: a target engagement position and a target orientation for the end effector 140; a target engagement surface (e.g., an accessible surface) on the luggage unit; a target gripping force for gripping the luggage unit; and/or single-arm or dual-arm manipulation. In one example, the controller 160 derives a target engagement specification that specifies: a set of target engagement surfaces for gripping the luggage unit based on the orientation of the luggage unit on the luggage carousel; and a target gripping force (e.g., for the gripper) based on the luggage type.

### 5.2.1 Luggage Characteristic Embeddings

In one variation, as shown in FIG. 4, the controller 160 can: generate an embedding encoding a set of luggage characteristics (e.g., luggage type, side surface profile, dimensions) of a luggage unit selected for retrieval; access an engagement specification database containing a population of historical embeddings encoding luggage characteristics of luggage units and labeled with target engagement specifications associated with successful retrieval of luggage units; identify an embedding, in the population of embeddings, that corresponds to luggage units with similar (or identical) characteristics to the selected luggage unit; and extract an engagement specification—implemented to successfully retrieve a similar luggage unit—from the embedding.

In one example, the controller 160 can: select a first luggage unit (e.g., a hard-sided suitcase) for retrieval from the luggage carousel and detect a first set of luggage characteristics (e.g., a “hard-sided luggage” type, a maximum dimension of 25 inches) of the first luggage unit; and generate a first embedding encoding the first set of luggage characteristics of the first luggage unit. The controller 160 can then identify a first historical embedding, in the population of historical embeddings, the first historical embedding: proximal the first embedding; and labeled with the first target engagement specification that specifies luggage manipulation via a single robotic arm 130.

Additionally, the controller 160 can: select a second luggage unit (e.g., a relatively-large, soft-sided duffel bag) for retrieval from the luggage carousel and detect a second set of luggage characteristics (e.g., deformable material, maximum dimension of 32 inches, absence of gripping points) of the second luggage unit; and generate a second embedding encoding the second set of luggage characteristics of the second luggage unit. The controller 160 can then identify a second historical embedding, in the population of historical embeddings, the second historical embedding: proximal the second embedding; and labeled with the second target engagement specification that specifies luggage manipulation via a pair of robotic arms 130 (i.e., dual-arm manipulation).

Accordingly, the controller 160 can retrieve prior successful luggage-manipulation strategies for luggage units with similar characteristics, thereby reducing trial-and-error, improving reliability of engagement, and adapting manipulation strategies to a wide range of luggage types in near real-time.

### 5.2.2 Gripping Model

In one variation, the controller 160 can execute a gripping model to calculate a target engagement specification (e.g., end effector 140 orientation, suction force, gripping force) for the end effector 140 to engage a first luggage unit based on a first set of luggage characteristics and a first orientation of the first luggage unit on the luggage carousel. For example, the controller 160 can implement template matching techniques to identify a second luggage unit: stored in the gripping model and labeled with successful retrieval from the luggage carousel by instances of the robotic system 102; exhibiting a second set of luggage characteristics matching (or similar to) the first set of luggage characteristics; and exhibiting a second orientation matching (or similar to) the first orientation. The controller 160 can then extract an engagement specification—representing specifications of the robotic system 102 (e.g., the engagement orientation of the end effector 140) during retrieval of the second luggage unit—from the luggage carousel.

In one example, the controller 160 can: select a first hard-sided suitcase for autonomous retrieval from the luggage carousel; detect a first dimension size of the first hard-sided suitcase and a “hard-sided suitcase” luggage type of the first luggage unit; and detect a first accessible side (e.g., an upward facing side) of the first hard-sided suitcase. The controller 160 can then identify a second hard-sided suitcase: labeled with successful retrieval in the gripping model; and exhibiting a second dimension matching the first dimension; and exhibiting a second accessible side matching the first accessible side.

In response to identifying the second hard-sided suitcase—associated with successful retrieval from the luggage carousel and exhibiting characteristics similar or identical to the first hard-sided suitcase, the controller 160 can extract an engagement specification associated with the second hard-sided suitcase defining: a vertical engagement orientation of the end effector 140; a suction force applied to the second accessible side by the end effector 140; and a gripping force applied to the sides of the second hard-sided suitcase by the gripper.

Thus, in this variation, the robotic system 102 can implement a comprehensive gripping model—containing a population of previously-implemented engagement specifications associated with successful luggage retrieval—to derive a target engagement specification for a particular luggage unit selected for retrieval. By leveraging these previously-implemented engagement specifications, the robotic system 102 can reduce the likelihood of luggage handling errors, such as dropping or improperly gripping luggage, to increase luggage handling efficiency and mitigate damage inflicted on luggage during manipulation.

### 5.3 Robotic Arm Engagement Path

Blocks of the method S100 recite: autonomously navigating a platform 110 of the robotic system 102 to collocate a robotic arm 130, arranged on the platform 110, with the luggage unit in Block S140; and maneuvering the robotic arm 130 to locate an end effector 140, arranged on a distal end of the robotic arm 130, in a target engagement pose defined in the target engagement specification in Block S150. Generally, in Block S150, the controller 160 can: access a target engagement pose from the target engagement specification, the target pose defining a target position and a target orientation for the end effector 140 to engage the luggage unit; and derive an engagement path for the robotic arm 130 to maneuver the end effector 140 to the target engagement pose while avoiding collisions with objects located in the autonomous loading zone (e.g., luggage carts, luggage units).

In one variation, upon selecting a luggage unit for retrieval, the controller 160 can: detect a current position of the luggage unit on the luggage carousel at a current time based on an image captured by an optical sensor 150 (e.g., a stationary optical sensor 150) arranged within the luggage bay; and predict a future position of the luggage unit on the luggage carousel at a future time. In particular, the controller 160 can predict the future position of the luggage unit based on: the current position of the luggage unit; a difference between the current time and the future time; and a velocity (e.g., a known velocity) of the luggage carousel. The controller 160 can then trigger the platform 110 to navigate along the autonomous work zone to align the robotic arm 130 to the position of the luggage unit at the future time, such that the robotic arm 130 is adjacent the luggage unit and positioned to retrieve the luggage unit at the future time.

In one variation, upon selecting a luggage unit for retrieval, the controller 160 can: access a first image depicting the luggage unit at a first position (e.g., proximal the inlet of the luggage carousel) at a first time; and trigger an optical sensor 150—arranged on the platform 110—to capture a second image depicting a second position of the luggage unit at a second time. The controller 160 can then: interpret a distance traveled by the luggage unit between the first position to the second position; and calculate a velocity of the luggage unit (e.g., the velocity of the luggage carousel) based on the distance traveled by the luggage unit and a difference between the first time and the second time. In response to detecting the luggage unit within the work zone (i.e., during a revolution on the luggage carousel), the controller 160 can then trigger the platform 110 to navigate along the autonomous work zone at the velocity to collocate the robotic arm 130 adjacent the luggage unit during engagement.

Generally, the robotic system 102 can align the platform 110 to the luggage unit while maneuvering the robotic arm 130 into position to engage the luggage unit. In one implementation, the controller 160 can: access a set of (i.e., one or more) target engagement surfaces on the luggage unit—for engaging the luggage unit—specified in the target engagement specification; access a target engagement pose—for the end effector 140 to engage the set of target engagement surfaces—specified in the target engagement specification; derive a current position of the end effector 140 relative to the luggage unit, such as based on an image captured by an optical sensor 150 arranged on the platform 110; and derive an engagement path for the robotic arm 130 to maneuver the end effector 140 from the current position to the target engagement pose for retrieval of the luggage unit.

### 5.4 Luggage Engagement+Retraction Path

Blocks of the method S100 recite: triggering the end effector 140 to engage the luggage unit according to the target engagement specification in Block S160; and retracting the robotic arm 130 from the luggage carousel to extract the luggage unit from the luggage carousel in Block S152. Generally, the controller 160 can: trigger the robotic arm 130 to maneuver along the engagement path to locate the end effector 140 in the target engagement pose; trigger the end effector 140 to engage the luggage unit according to the target engagement specification (e.g., a target gripping force) in Block S160; and trigger the robotic arm 130 to retract (e.g., vertically, horizontally) to extract the luggage unit from the luggage carousel in Block S152.

In one implementation, once the end effector 140 reaches the target engagement pose, the robotic system 102 can drive the end effector 140 toward the luggage unit to engage the end effector 140 against the luggage unit. For example, when executing the engagement path, the robotic arm 130 can: maneuver the end effector 140 to a target position vertically offset above the luggage unit by a height greater than a maximum estimated height of the luggage unit; maneuver the end effector 140 to a target orientation facing downward toward a top surface (i.e., an accessible surface) of the luggage unit; and then lower the end effector 140 downward toward the luggage unit. Alternatively, in another example, the robotic arm 130 can: maneuver the end effector 140 to a target position horizontally offset from the luggage unit and a target orientation facing toward a side surface (i.e., an accessible surface) of the luggage unit; and then horizontally maneuver the end effector 140 toward the luggage unit.

In one example, the controller 160 can implement methods and techniques described above to derive a target engagement specification for retrieving a luggage unit that specifies: a set of target engagement surfaces for gripping the luggage unit based on an orientation of the luggage unit on the luggage carousel; and a target gripping force based on a luggage type of the luggage unit. The controller 160 can then: maneuver the end effector 140 toward the luggage unit; and, in response to detecting a position of the end effector 140 coinciding with the target engagement pose, trigger the gripper to engage the luggage unit at the set of target engagement surfaces and retract inwardly to grip the luggage unit according to the target gripping force.

In another example, in response to the set of rams retracting a threshold distance, the gripper can transiently rotate from an extended position to a retracted position to enable the suction head to access a particular luggage unit. In particular, in this example, in response to detecting contact between the end effector 140 and the luggage unit, the controller 160 can trigger the set of rams to retract inwardly by a threshold distance to drive the gripper toward the luggage unit. The controller 160 can then, in response to failing to detect engagement between the gripper and the luggage unit, trigger the gripper to transiently rotate to the retracted position.

In another example, in response to detecting contact between the end effector 140 and the luggage unit (e.g., via a force sensor arranged on the end effector 140), the controller 160 can: trigger a vacuum pump to draw a vacuum at a suction head—arranged on the end effector 140—to transiently retain the luggage unit to the end effector 140; and actuate the gripper to retract horizontally inward to apply a gripping force to the sides of the luggage unit.

In one implementation, the robotic arm 130 can retract from the luggage carousel to extract the luggage unit from the luggage carousel. In particular, in response to detecting engagement between the end effector 140 and the luggage unit, the controller 160 can: derive a retraction path for the robotic arm 130 to maneuver the end effector 140 from the target engagement pose to a retracted pose; and trigger the robotic arm 130 to maneuver the end effector 140 along the retraction path to extract the luggage unit from the luggage carousel.

### 5.5 Target Storage Pose+Delivery Path

Blocks of the method S100 recite: deriving a target storage pose for stowing a luggage unit within a luggage cart in Block S134; maneuvering the robotic arm 130 to locate the luggage unit in the target storage pose in the luggage cart located within the airport luggage bay in Block S154; and triggering the end effector 140 to disengage the luggage unit in Block S162. Generally, in Block S154, the controller 160 can: derive a target storage pose (i.e., the delivery position and orientation) for the luggage unit within a luggage cart assigned to the luggage unit; and execute a delivery path to maneuver the end effector 140 to position the luggage unit in the target storage pose.

The controller 160 can then: derive a delivery path for the robotic arm 130 to maneuver the end effector 140 to locate the luggage unit in the target storage pose while avoiding collisions with objects located in the autonomous loading zone (e.g., luggage carts, the platform 110) and/or objects located within the interior volume of the target luggage cart (e.g., luggage units); and trigger the robotic arm 130 to maneuver along the delivery path to locate the luggage unit in the target storage pose within the target luggage cart.

### 5.5.1 Target Storage Pose Derivation: Stationary Optical Sensor

In one variation, as shown in FIG. 3, the controller 160 can access an image captured by an optical sensor 150, defining a field of view intersecting the luggage carousel and the luggage cart, and depicting the luggage unit located on the luggage carousel and unoccupied volumes within the luggage cart. The controller 160 can then: detect a set of luggage characteristics of the luggage unit based on the image; detect an unoccupied volume within the luggage cart, compatible with the set of luggage characteristics of the luggage unit, based on the image; and derive the target storage pose, intersecting the unoccupied volume, for stowing the luggage unit within the luggage cart.

In one example, the controller 160 can: select a soft-sided luggage unit (e.g., a duffel bag) for retrieval; and derive a target storage pose, above a stack of hard-sided suitcases, within the luggage cart. Thus, in this example, the controller 160 can position the soft-sided duffel bag on top of the hard-sided suitcases to prevent deformation of the duffel bag and to preserve stability of the luggage stack.

In another example, the controller 160 can: detect a dimension (e.g., a volume) of the luggage unit based on the image; detect an unoccupied volume (e.g., an open volume between two columns of luggage) within the luggage cart, congruent with the dimension of the luggage unit, based on the image; and derive the target storage pose, intersecting the unoccupied volume, for stowing the luggage unit within the luggage cart.

Thus, in this variation, the controller 160 can access images captured by a single optical sensor 150 (e.g., a stationary optical sensor 150 arranged in the luggage bay) to detect both luggage units located on the luggage carousel and unoccupied volumes within the luggage cart. Therefore, the robotic system 102 can reduce reliance on onboard optical sensors 150, decrease computational resources otherwise required to construct and maintain a spatial map of the luggage bay, and mitigate distortions that may arise from onboard sensors capturing images while the robotic system 102 is in motion.

### 5.5.2 Target Storage Pose Derivation: Onboard Optical Sensor

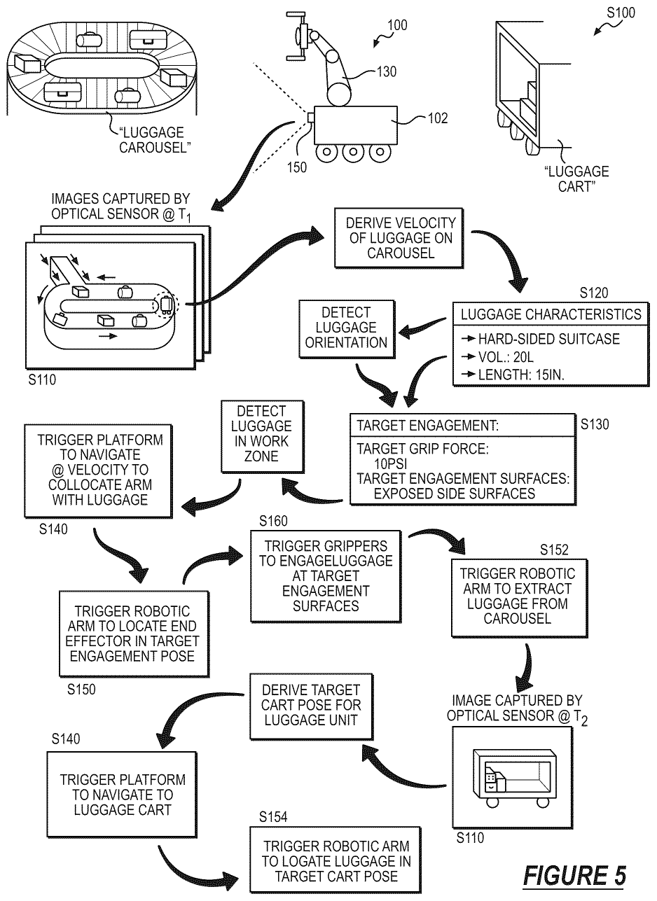

In one variation, as shown in FIG. 5, the controller 160 can access images captured by an optical sensor 150 arranged on the platform 110 to detect luggage units on the luggage carousel and detect unoccupied volumes—for stowing luggage units—within the luggage cart. In this variation, the controller 160 can: access a first image captured by the optical sensor 150 when the robotic system 102 is located at a first position (e.g., proximal the luggage unit on the luggage carousel) within the luggage bay; and detect the luggage unit entering the autonomous work zone and the set of luggage characteristics (e.g., a dimension, a luggage type) of the luggage unit based on a first image captured by the optical sensor 150.

The controller 160 can then: access a second image captured by the optical sensor 150 when the robotic system 102 is located at a second position (e.g., proximal the luggage cart assigned to the luggage unit) within the luggage bay; detect an unoccupied volume within the luggage cart, compatible with the set of luggage characteristics of the luggage unit, based on a second image captured by the optical sensor 150; and derive the target storage pose, intersecting the unoccupied volume, for stowing the luggage unit within the luggage cart.

In one example, the controller 160 can: implement methods and techniques described above to detect a dimension (e.g., a maximum length) of a luggage unit, extracted from the luggage carousel by the robotic arm 130, based on a first image captured by the optical sensor 150; trigger the platform 110 to navigate along the autonomous work zone, with the luggage unit retained by the end effector 140, to proximal the luggage cart; trigger the optical sensor 150 to capture a second image depicting unoccupied volumes within the luggage cart; detect an unoccupied volume within the luggage cart, congruent with the dimension of the luggage unit, based on the second image; and derive the target storage pose, intersecting the unoccupied volume, for stowing the luggage unit within the luggage cart.

In another example, the controller 160 can: detect a set of luggage characteristics (e.g., volume, luggage type, maximum dimensions, shape) of the luggage unit based on the virtual luggage model of the luggage unit; retrieve a three-dimensional representation of an interior volume of a target luggage cart assigned to the luggage unit; and, based on the virtual luggage model of the luggage unit and the three-dimensional representation of the target luggage cart, derive a target storage pose for the luggage unit within the target luggage cart.

Thus, in this variation, the controller 160 can access images captured by an onboard optical sensor 150 to detect luggage units and unoccupied volumes, such as when views from a stationary optical sensor 150 are obstructed or unavailable. By relying on the onboard optical sensor 150, the robotic system 102 can maintain accurate perception of both luggage units and luggage cart interiors while operating in dynamic or partially occluded environments within the luggage bay.

### 5.5.3 Target Storage Pose Derivation: Series of Images

In one variation, as shown in FIG. 2, the controller 160 can maneuver the luggage unit—through the field of view of an optical sensor 150—to generate a virtual luggage model (e.g., a three-dimensional mesh, point cloud, depth map, or surface model) of the luggage unit that represents a three-dimensional geometry of the luggage unit. The controller 160 can then derive the target storage pose for the luggage unit based on this virtual luggage model.

In particular, in this variation, the robotic system 102 can: maneuver the end effector 140 and the luggage unit extracted from the luggage carousel through the field of view of an optical sensor 150 (e.g., arranged on the platform 110); record a series of images of the luggage unit—via the optical sensor 150—as the luggage unit traverses through the field of view of optical sensor 150; and compile visual characteristics of luggage—extracted from these images—into a comprehensive representation of the luggage unit, such as a three-dimensional mesh, point cloud, depth map, or surface model. More specifically, the robotic arm 130 can: retract from the luggage carousel to extract the luggage unit, retained by the end effector 140, from the luggage carousel; and traverse the luggage unit through the field of view of the optical sensor 150. For example, the controller 160 can access an image captured by an optical sensor 150 arranged on the platform 110 and defining a field of view intersecting a path of the end effector 140 between the luggage carousel and the luggage cart. In another example, the controller 160 can access an image captured by an optical sensor 150 (e.g., a stationary optical sensor 150) located at a fixed location within the luggage bay and defining a field of view intersecting the path of the end effector 140 between the luggage carousel and the luggage cart.

In this variation, the controller 160 can: access a set of images captured by the optical sensor 150 during traversal of the luggage unit through the field of view of the optical sensor 150; and compile the set of images into a virtual luggage model representing three-dimensional surfaces and dimensions of the luggage unit. The controller 160 can then: access an image depicting unoccupied volumes within the luggage cart, such as an image captured by an optical sensor 150 arranged on the robotic system 102 or an optical sensor 150 arranged at a fixed location within the luggage bay; detect an unoccupied volume within the luggage cart, compatible with the virtual luggage model, based on the image; and derive the target storage pose, intersecting the unoccupied volume, for stowing the luggage unit within the luggage cart.

In one variation, upon extraction of the luggage unit from the luggage carousel, the controller 160 can: trigger the optical sensor 150 to capture an image depicting the luggage unit and the end effector 140; and characterize presence of the luggage unit within the field of view of the optical sensor 150. In response to detecting the luggage unit within the field of view of the optical sensor 150, the controller 160 can derive a scanning path for the robotic arm 130 to maneuver (e.g., horizontally rotate) the end effector 140 and the luggage unit through the field of view of the optical sensor 150.

Alternatively, in response to failing to detect the luggage unit within the field of view of the optical sensor 150 and/or in response to failing to derive a viable scanning path (i.e., a scanning path resulting in no collisions when initiated at the retracted pose), the controller 160 can derive a transfer path to transition the luggage unit from the retracted pose (e.g., above the luggage carousel) to a transition pose (e.g., removed from the luggage carousel). The controller 160 can then implement methods and techniques described above to derive a scanning path.

In one example, the controller 160 can then: trigger the robotic arm 130 to maneuver the end effector 140 along the scanning path; record a series of images of the luggage unit—via the optical sensor 150—as the end effector 140 rotates the luggage unit (e.g., through a 360° revolution) within the field of view of the optical sensor 150; and compile the series of images into a virtual luggage model of the luggage unit.

### 5.5.4 Target Storage Pose Derivation: Luggage Model Database

In one variation, as shown in FIG. 3, the controller 160 can: encode luggage characteristics of a luggage unit—selected for retrieval from the luggage carousel—into an embedding; access a luggage model database (e.g., a vector database, an n-dimensional space) containing a population of historical embeddings encoding luggage characteristics of luggage units (i.e., luggage units previously-manipulated by instances of the robotic system 102); and identify an embedding stored in the luggage model database that corresponds to a luggage unit—previously-manipulated by an instance of the robotic system 102—exhibiting similar (or identical) luggage characteristics to the luggage unit selected for retrieval. The controller 160 can then: extract a virtual luggage model from the historical embedding that represents three-dimensional surfaces and dimensions of the previously-manipulated luggage unit; and, based on this virtual luggage model, derive a target storage pose for the luggage unit selected for retrieval.

In particular, in this variation, the controller 160 can: access an image depicting a luggage unit located on the luggage carousel; detect a set of luggage characteristics (e.g., volume, luggage type, maximum dimensions, shape) of the luggage unit based on the image; generate an embedding encoding the set of luggage characteristics of the luggage unit; identify a historical embedding, in the population of historical embeddings, proximal the embedding; and extract a virtual luggage model, encoded in the historical embedding, representing three-dimensional surfaces and dimensions of a previously-manipulated luggage unit resembling the luggage unit.

The controller 160 can then: detect an unoccupied volume within the luggage cart, compatible with the virtual luggage model, such as based on an image captured by an optical sensor 150 arranged on the robotic system 102 or an optical sensor 150 arranged at a fixed location within the luggage bay; and derive the target storage pose, intersecting the unoccupied volume, for stowing the luggage unit within the luggage cart.

### 5.5.5 Target Storage Pose Refinement

In one variation, the controller 160 can: trigger the robotic arm 130 to execute a partial maneuver along the delivery path; trigger an optical sensor 150 to capture one or more images of the luggage cart; and detect an obstruction—blocking placement of the luggage unit in the target storage pose—based on the one or more images of the luggage cart. In response to detecting the obstruction, the controller 160 can: detect unoccupied volumes within the luggage cart based on the one or more images of the luggage cart; and derive a new target luggage pose for the luggage unit intersecting an unoccupied volume within the luggage cart (e.g., based on known luggage characteristics of the luggage unit). Accordingly, the controller 160 can interpret cart-level images to verify viability of the target storage pose for the luggage unit prior to triggering the robotic arm 130 to complete the delivery path.

### 6. Variation: Robotic System on Conveyor

In one variation, as shown in FIGS. 2 and 8A-8C, the robotic system 102 can include: a conveyor 180 interposed between the luggage carousel and luggage carts; and a platform 110 mounted to the conveyor 180 and configured to navigate along the conveyor 180. In this variation, the controller 160 can: select a luggage unit, depicted in an image captured by an optical sensor 150 (e.g., arranged proximal the inlet of the luggage carousel, arranged on the platform 110) for autonomous retrieval; extract a set of luggage characteristics of the luggage unit from the image; access a target engagement specification for engaging the luggage unit based on the set of luggage characteristics; in response to detecting the luggage unit entering the autonomous work zone, trigger the platform 110 to navigate along the conveyor 180 to collocate the robotic arm 130 with the luggage unit; trigger the robotic arm 130 to maneuver the end effector 140 to a target engagement pose for retrieval of the luggage unit according to the target engagement specification; trigger the end effector 140 to engage the luggage unit; trigger the robotic arm 130 to extract the luggage unit from the luggage carousel; and trigger the platform 110 to navigate along the conveyor 180 to align the luggage unit, retained by the end effector 140, to a target storage pose for the luggage unit.

### 7. Luggage Retrieval Sequence: Luggage Characteristics

In one variation, the controller 160 can: access extant luggage data representing characteristics (e.g., luggage dimensions, types, and/or weights recorded at a luggage check-in kiosk) of luggage units entering the luggage carousel; and define an order for sequentially retrieving luggage units from the luggage carousel based on the extant luggage data.

For example, the controller 160 can: access a luggage type of a set of three luggage units entering the luggage carousel and assigned to a luggage cart, the set of three luggage units including a hard-sided suitcase, a soft-sided suitcase, and a duffel bag; order the hard-sided suitcase in a first slot for retrieval and placement proximal a floor of the luggage cart; order the soft-sided suitcase in a second slot for retrieval and placement above (i.e., on top of) the hard-sided suitcase; and order the duffel bag in a third slot for retrieval and placement above the soft-sided suitcase. In this example, the robotic system 102 can initially place the hard-sided suitcase and subsequently place the soft-sided luggage units (i.e., the soft-sided suitcase and the duffel bag) atop the hard-sided suitcase to protect the contents of the soft-sided luggage units.

Accordingly, rather than retrieving the next available luggage unit from the luggage carousel, the robotic system 102 can define a sequence of retrievals to selectively retrieve luggage units, such as based on size, type, and/or weight. The robotic system 102 can thus: increase luggage handling efficiency by maximizing space usage within the interior volume of the luggage cart; and mitigate damage to luggage (and luggage contents) resulting from misplacement of luggage within the luggage cart.

### 8. Luggage Retrieval Sequence: Luggage Cart Assignments

In one variation, the controller 160 can: access luggage cart assignments corresponding to luggage units entering the luggage carousel; and define an order for sequentially retrieving luggage units from the luggage carousel based on the luggage cart assignments.

For example, the controller 160 can access a luggage type of a set of three luggage units entering the luggage carousel and assigned to a luggage cart, the set of three luggage units including: a hard-sided suitcase assigned to a first luggage cart arranged proximal a right end of the autonomous loading zone; a soft-sided suitcase assigned to a second luggage cart arranged proximal a left end of the autonomous loading zone; and a duffel bag assigned to a third luggage cart arranged proximal a middle of the autonomous loading zone.

The controller 160 can then, in response to detecting a current position of the platform 110 proximal the left end of the autonomous loading zone: order the soft-sided suitcase in a first slot for retrieval and placement in the second luggage cart (i.e., the left-side luggage cart); order the duffel in a second slot for retrieval and placement in the third luggage cart (i.e., the middle luggage cart); and order the hard-sided suitcase in a third slot for retrieval and placement in the first luggage cart (i.e., the right-side luggage cart).

Accordingly, rather than retrieving the next available luggage unit from the luggage carousel, the robotic system 102 can define a sequence of retrievals to minimize horizontal movements of the platform 110 along luggage carousel. The robotic system 102 can thus: increase luggage handling efficiency by reducing transition times between each successive luggage unit retrieval; and mitigate damage and/or wear resulting from excessive horizontal movements by the platform 110.

### 9. Storage Tray+Opportunistic Luggage Retrieval

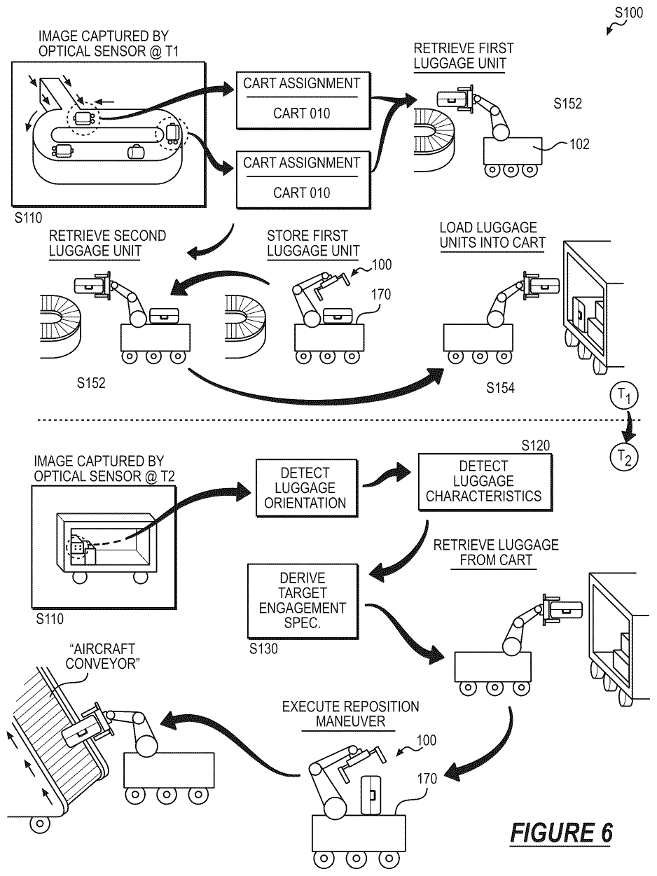

In one variation, in which the robotic system 102 includes a tray 170—arranged on the platform 110 and defining a planar surface—the robotic system 102 can opportunistically retrieve luggage units from the carousel and store these luggage units on the tray 170. In one example, the robotic system 102 can retrieve multiple luggage units assigned to a common luggage cart and retain these luggage units on the tray 170, such that the robotic system 102 can transport and deliver the group of luggage units to the luggage cart in a single operation, as shown in FIG. 6.

In particular, in this example, the controller 160 can: access an image depicting luggage units located on the luggage carousel; detect a first luggage unit and a second luggage unit, depicted in the image, that share a common luggage cart assignment; and, in response to detecting this common luggage cart assignment, implement methods and techniques described above to retrieve the first luggage unit from the luggage carousel via the robotic arm 130. The controller 160 can then: trigger the robotic arm 130 to locate the first luggage unit on the tray 170; implement methods and techniques described above to extract the second luggage unit from the luggage carousel via the robotic arm 130; trigger the platform 110 to navigate to the luggage cart; trigger the robotic arm 130 to locate the second luggage unit in a second target storage pose within the luggage cart; and trigger the robotic arm 130 to relocate the first luggage unit from the tray 170 to the first target storage pose within the luggage cart.

In another example, the robotic system 102 can retrieve a luggage unit (e.g., an early-check-in luggage unit) that arrives on the luggage carousel prior to arrival of the luggage cart assigned to the luggage unit, as shown in FIG. 3. In this example, the robotic system 102 can transiently remove the luggage unit from the luggage carousel to prevent congestion, reduce the likelihood of misplacement, and preserve carousel capacity for subsequently arriving luggage units. Furthermore, the robotic system 102 can execute subsequent retrieval and placement of additional luggage units while transiently storing the luggage unit at the storage tray 170.

In particular, in this example, during a first time period, the controller 160 can: access or detect a first location of the luggage cart, assigned to a luggage unit, within the airport; and, in response to detecting the first location of the luggage cart outside of the luggage bay, trigger the robotic arm 130 to locate the luggage unit on the tray 170. In particular, the controller 160 can: trigger the robotic arm 130 to maneuver the luggage unit, retained by the end effector 140, over the tray 170; and trigger the end effector 140 to disengage the luggage unit to locate the luggage unit on the tray 170.

During a second time period succeeding the first time period, the controller 160 can then: detect a second location of the luggage cart within the airport; and, in response to detecting the second location of the luggage cart within the airport luggage bay, trigger the robotic system 102 to place the luggage unit within the luggage cart. In particular, the controller 160 can: trigger the platform 110 to navigate along the autonomous work zone to align the robotic arm 130 to the luggage cart; trigger the robotic arm 130 to retrieve the luggage unit from the tray 170 via the end effector 140; and trigger the robotic arm 130 to locate the luggage unit in the target storage pose within the luggage cart. Thus, in this example, the robotic system 102 can transiently store the luggage unit on the tray 170 while the assigned luggage cart remains unavailable in the luggage bay. Alternatively, the robotic system 102 can: transfer the luggage unit to a designated storage area within the luggage bay; and retrieve the luggage unit from the storage area for subsequent placement in the assigned luggage cart once the luggage cart becomes available.

### 9.1 Repositioning Maneuver

In another variation, the robotic system 102 can temporarily position a luggage unit on the tray 170 during a reposition maneuver by the robotic arm 130, as shown in FIG. 6. In one example, the robotic arm 130 can: engage the luggage unit, via the end effector 140, at a first engagement position on the luggage unit when the luggage unit is located within the luggage cart; maneuver the luggage unit to the tray 170 while the luggage unit is retained by the end effector 140 at the first engagement position; and disengage the end effector 140 to position the luggage unit on the tray 170. The robotic arm 130 can then: engage the luggage unit, via the end effector 140, at a second engagement position on the luggage unit, the second engagement position different from the first engagement position; and maneuver the luggage unit to a target delivery pose on an aircraft conveyor while the luggage unit is retained by the end effector 140 at the second engagement position. Thus, in this variation, the robotic system 102 can temporarily position luggage units on the tray 170 during retrieval of luggage units exhibiting limited accessibility (e.g., a single exposed handle or accessible surface), wherein a single gripping maneuver may be insufficient to securely retain the luggage unit. By leveraging the tray 170 as an intermediate staging surface, the robotic system 102 can disengage and subsequently re-engage the luggage unit to improve grasp reliability and stable delivery of the luggage unit (e.g., to an aircraft conveyor).

### 10. Luggage Retrieval Confidence+Operator Alerts

In one variation, as shown in FIG. 4, the controller 160 can calculate a confidence score representing a likelihood of successful retrieval of a particular luggage unit from the luggage carousel. For example, the controller 160 can calculate a relatively low confidence score for a luggage unit arranged on the luggage carousel at a particular orientation such that the luggage unit lacks an accessible side surface for engagement or is partially constrained beneath adjacent luggage units. In response to calculating a confidence score that falls below a threshold score, the controller 160 can serve an alert to an operator (e.g., airport personnel) prompting manual retrieval of the luggage unit.

In one example, the controller 160 can: detect a luggage unit (e.g., a golf club case), located on the luggage cart, exhibiting a set of luggage characteristics (e.g., elongated geometry, irregular side surfaces) and an orientation (e.g., lacking clearance for the end effector 140); and calculate a confidence score (e.g., 50%) for successful retrieval of the luggage unit by the robotic arm 130 based on the set of luggage characteristics and the orientation. In response to the confidence score falling below the threshold score, the controller 160 can generate an alert including: a region of the image depicting the luggage unit; and a prompt to manually retrieve the luggage unit from the luggage carousel proximal a manual loading zone adjacent the autonomous work zone. The controller 160 can then serve the alert to an operator via a user interface (e.g., a display, a monitor arranged proximal the luggage carousel) located within the airport luggage bay. For example, the controller 160 can transmit the alert to a display located within the airport luggage bay.

### 11. Engagement Failure

In one variation, in response to detecting contact between the end effector 140 and the luggage unit, the controller 160 can interpret signals output by sensors (e.g., a force sensor) arranged on the end effector 140 to detect successful or unsuccessful engagement between the end effector 140 and the luggage unit. For example, the controller 160 can: monitor a suction force applied to the luggage unit by a suction head of the end effector 140; and monitor a gripping force applied to the luggage unit by a gripper of the end effector 140. In response to detecting failed engagement between the end effector 140 and the luggage unit (e.g., detecting a drop in the suction force and/or gripping force), the controller 160 can: halt retrieval of the luggage unit; and derive an alternative target engagement specification for retrieving the luggage unit.

For example, the controller 160 can: trigger an optical sensor 150 to capture a new image depicting the luggage unit (e.g., from a new point of view); detect a second set of luggage characteristics of the luggage unit based on the new image; and implement methods and techniques described above to derive an alternative target engagement specification based on the second set of luggage characteristics. The controller 160 can then implement methods and techniques described above to trigger the robotic arm 130 and end effector 140 to attempt retrieval of the luggage unit according to the alternative target engagement specification. Furthermore, the controller 160 can store the initial target engagement specification—implemented during the failed engagement with the luggage unit—in association with unsuccessful retrieval from the luggage carousel for the luggage unit.

Alternatively, in response to detecting failed engagement between the end effector 140 and the luggage unit, the controller 160 can: re-extract luggage characteristics of the luggage unit from an image captured by an optical sensor 150 arranged on the robotic system 102; implement methods and techniques described above to derive an alternative target engagement specification based on these luggage characteristics; and then load and execute this alternative target engagement specification to reattempt autonomous extraction of the luggage unit from the luggage carousel.

In another variation, in response to detecting failed engagement between the end effector 140 and the luggage unit, the controller 160 can implement methods and techniques described above to: generate an alert including the image depicting the luggage unit on the luggage carousel and a prompt to manually retrieve the luggage unit; and serve the notification to the user via a user interface.

### 12. Luggage Transfer From Luggage Cart to Luggage Carousel

Generally, the robotic system 102 can: retrieve luggage units from luggage carts arranged in the autonomous loading zone (e.g., from an incoming aircraft); and load the luggage units onto the luggage carousel within the work zone (e.g., for dispersion to a luggage claim facility within an airport).

### 12.1 Luggage Selection+Target Engagement Specification

Generally, the robotic system 102 can: detect luggage units located in the luggage cart; select a luggage unit for autonomous retrieval; and derive the target engagement specification for the end effector 140 to engage the luggage unit.

In one implementation, the controller 160 can: access an image depicting a set of luggage units located in the interior volume of the luggage cart; select a first luggage unit—depicted in the image—for autonomous retrieval from the luggage cart; extract a first set of luggage characteristics (e.g., luggage type) of the first luggage unit from the image; and detect a first orientation of the luggage unit (e.g., accessible sides, angle relative to the platform 110). The controller 160 can then implement methods and techniques described above to derive a target engagement specification for the end effector 140 to engage the luggage unit based on the first set of luggage characteristics and the first orientation depicted in the image.

### 12.2 Engagement Path+Luggage Engagement+Retraction Path

Generally, the controller 160 can: derive an engagement path for the robotic arm 130 to maneuver the end effector 140 to a target engagement pose—according to the engagement specification—to engage the luggage unit; and derive a retraction path for the robotic arm 130 to maneuver the end effector 140 to a retracted position to extract the luggage unit from the luggage cart while avoiding collisions with objects located in the autonomous loading zone (e.g., luggage carts, luggage units) and/or luggage units located on the luggage carousel.

In one implementation, the controller 160 can implement methods and techniques described above: to select a luggage unit for autonomous retrieval from the luggage cart; to trigger an optical sensor 150 to capture an image depicting the luggage unit within the luggage cart; and to interpret a vertical height of the luggage unit based on the image. The controller 160 can then: trigger the robotic arm 130 to maneuver along the engagement path to locate the end effector 140 in the target engagement pose; trigger the end effector 140 to engage the luggage unit (e.g., an exposed top surface of a soft-sided suitcase) according to the target engagement specification; and trigger the robotic arm 130 to extract the luggage unit from the luggage cart.

The controller 160 can then implement methods and techniques described above: to detect contact between the end effector 140 and the luggage unit; and trigger the end effector 140 to retain the luggage unit. For example, in response to detecting contact between the end effector 140 and the luggage unit, the controller 160 can trigger the end effector 140: to apply a suction force to the luggage unit via the suction head; and to apply a gripping force to the luggage unit via the gripper. In response to detecting successful engagement between the end effector 140 and the luggage unit, the controller 160 can: derive a retraction path for the robotic arm 130 to maneuver the end effector 140 from the target engagement pose to a retracted pose; and trigger the robotic arm 130 to maneuver the end effector 140 along the retraction path to extract the luggage unit from the luggage cart.

### 12.3 Delivery Path+Target Carousel Pose

Generally, the robotic system 102 can: identify a target carousel pose (i.e., the delivery position and orientation) for the luggage unit on the luggage carousel; and execute a delivery path to maneuver the end effector 140 to position the luggage unit in the target carousel pose.

In one implementation, the controller 160 can: trigger an optical sensor 150 to capture an image depicting the luggage carousel; and identify a target carousel pose for the luggage unit on the luggage carousel based on the image. The controller 160 can then: derive a delivery path for the robotic arm 130 to maneuver the end effector 140 to locate the luggage unit in the target carousel pose while avoiding collisions with luggage units located on the luggage carousel; trigger the platform 110 to navigate to a position adjacent the target carousel pose on the luggage carousel and at a vertical height of the luggage carousel; and trigger the robotic arm 130 to maneuver along the delivery path to locate the luggage unit in the target carousel pose on the luggage carousel.

In particular, the robotic system 102 can position the luggage unit in the target carousel pose including: a target carousel position, such as an unobstructed position on the luggage carousel; and a target carousel orientation, such as a side surface of a rolling luggage bag (i.e., avoiding the wheel-bearing side to prevent instability), or a bottom surface of a duffel bag (i.e., aligning the bag with its handles facing upward for optimized retrieval and transport).

### 13. Luggage Transfer Between Luggage Cart & Aircraft Loading Conveyor

Generally, as shown in FIGS. 6 and 8D, the robotic system 102 can: retrieve luggage units from luggage carts arranged in an autonomous aircraft loading zone (e.g., proximal an outbound aircraft); and load the luggage units onto a section of an aircraft conveyor proximal the autonomous aircraft loading zone (e.g., for delivery to a stowage compartment of the outbound aircraft).

In one implementation, the robotic system 102 can: autonomously navigate within the airport luggage bay to transfer luggage units from the luggage carousel to luggage carts located within the airport luggage bay; and autonomously navigate along a tarmac to transfer luggage units from luggage carts, located on a tarmac proximal an aircraft, to an aircraft conveyor configured to convey luggage units into the aircraft.

In particular, in this implementation, during a first time period: the platform 110 can navigate along the autonomous work zone to a first position aligned to a luggage unit located on the luggage carousel (e.g., located in an indoor luggage bay); and the robotic arm 130 can retrieve the luggage unit from the luggage carousel and stow the luggage unit in the luggage cart (e.g., located in the indoor luggage bay). Then, during a second time period succeeding the first time period: the platform 110 can navigate along a tarmac, located at the airport (e.g., outdoors), to a second position aligned to the luggage unit within the luggage cart when the luggage cart is located on the tarmac proximal an aircraft; and the robotic arm 130 can retrieve the luggage unit from the luggage cart and position the luggage unit in a target delivery pose on the aircraft conveyor.

In this implementation, during the second time period, the controller 160 can: implement methods and techniques described above: to select a luggage unit for autonomous retrieval from the luggage cart; to trigger the robotic arm 130 to engage the luggage unit; to trigger the robotic arm 130 to maneuver the end effector 140 along the retraction path to extract the luggage unit from the luggage cart (e.g., onto the lift table); to derive a delivery path for the robotic arm 130 to maneuver the end effector 140 to locate the luggage unit in a target delivery pose on the aircraft conveyor; and to trigger the robotic arm 130 to maneuver the end effector 140 to locate the luggage unit in the target delivery pose.

In another implementation, the robotic system 102 can implement methods and techniques described above: to retrieve luggage units from aircraft conveyors (e.g., from an incoming aircraft); and load the luggage units into luggage carts arranged in the autonomous aircraft loading zone (e.g., for delivery to the luggage carousel).

### 13.1 Variation: Lift Table+Conveyor

In one variation, the robotic system 102 includes a lift table—mounted to the platform 110 and defining a planar surface—configured to vertically maneuver relative to the platform 110. In this variation, the controller 160 can: select a luggage unit for retrieval from a luggage cart; trigger the lift table to maneuver to a vertical height of the luggage unit; and trigger the robotic arm 130 to transfer (e.g., slide) the luggage unit from the luggage cart to the lift table. The controller 160 can then: derive a target delivery pose for the luggage unit on an aircraft conveyor; trigger the lift table to maneuver to a vertical height of the aircraft conveyor; and trigger the robotic arm 130 to relocate the luggage unit from the lift table to the aircraft conveyor.

In another variation, the robotic system 102 can include: the lift table; and a transfer conveyor configured to drive a luggage unit along the lift table and toward the luggage carousel. In this variation, the controller 160 can implement methods and techniques described above: to select a luggage unit for autonomous retrieval from the luggage cart; to trigger the robotic arm 130 to engage the luggage unit; to trigger the robotic arm 130 to maneuver the end effector 140 along the retraction path to transfer (e.g., slide) the luggage unit from the luggage cart to the lift table; and to derive a delivery path for the robotic arm 130 to maneuver the end effector 140 to locate the luggage unit in the target carousel pose.

The controller 160 can then: trigger the platform 110 to navigate to a position adjacent the target carousel pose on the luggage carousel; trigger the lift table to maneuver to a vertical height of the luggage carousel; and trigger the transfer conveyor to drive the luggage unit toward the luggage carousel. Accordingly, the controller 160 can trigger the transfer conveyor to transfer the luggage unit from the lift table to the target carousel pose. Thus, in this variation, the robotic system 102 can facilitate retrieval and repositioning of luggage units that are positioned in orientations difficult for the robotic arm 130 to initially access, thereby reducing the likelihood of luggage handling errors, such as dropping or improperly gripping luggage.

### 13.1.1 Reengagement Maneuver

In one variation, upon removing the luggage unit from the luggage cart and upon transferring the luggage unit to the lift table, the robotic system 102 can execute a reengagement maneuver to adjust the grip on the luggage unit. In particular, the controller 160 can: implement methods and techniques described above to trigger the robotic arm 130 to transfer a luggage unit from the luggage cart to the lift table; trigger the end effector 140 to disengage the luggage unit; trigger an optical sensor 150 (e.g., arranged on the robotic system 102) to record a series of images depicting the luggage unit on the lift table or otherwise access an image captured by this optical sensor; and implement methods and techniques described above to redefine a target engagement specification for engaging the luggage unit based on characteristics of the luggage unit detected in the series of images. The controller 160 can then: derive a reengagement maneuver for the robotic arm 130 to maneuver the end effector 140 to a target engagement pose—according to the engagement specification—to engage the luggage unit; and trigger the robotic arm 130 to execute the reengagement maneuver to locate the end effector 140 in the target engagement pose to re-engage the luggage unit prior to delivery to the luggage carousel.

Furthermore, in this variation, the controller 160 can: derive a virtual luggage model of the luggage unit based on the series of images; and, based on the virtual luggage model of the luggage unit and the image depicting the luggage carousel, derive the target storage pose for the luggage unit within the luggage cart.

### 14. Dual-Arm Coordination and Luggage Transfer

In one variation, the robotic system 102 includes a pair of robotic arms 130 configured to coordinate motion planning, end effector 140 orientation, and luggage engagement (e.g., gripping, suction) to jointly manipulate luggage units. For example, the pair of robotic arms 130 can cooperate to retrieve, stabilize, and place luggage units that exhibit: oversized dimensions (e.g., ski bags, golf cases); non-rigid or deformable structure (e.g., duffel bags, soft-shell suitcases); irregular geometry (e.g., tapered or asymmetrical luggage); and/or unbalanced mass distribution (e.g., single-wheel bags or top-heavy cases). By cooperating to engage and transport luggage units, the pair of robotic arms 130 can: reduce the risk of accidental drops, tipping, or slippage during lifting and transfer operations; distribute load across multiple contact points to prevent over-compression, deformation, or damage to soft or fragile luggage; maintain orientation of irregular or asymmetric luggage units for accurate placement within carts or bins; and stabilize dynamically shifting loads that may otherwise oscillate or pivot during single-arm manipulation.

### 14.1 Luggage Engagement Specification for Cooperating Robotic Arms

In one variation, the controller 160 can: detect luggage units—located on the luggage carousel—entering the work zone; select a luggage unit for autonomous retrieval; and derive a target engagement specification for the first end effector 140 of the first robotic arm 130 and the second end effector 140 of the second robotic arm 130 to engage the luggage unit. In this variation, the controller 160 can implement methods and techniques described above to: detect a set of luggage characteristics of a luggage unit selected for autonomous retrieval; and detect an orientation of the luggage unit (e.g., accessible sides, angle relative to the platform 110).

The controller 160 can then derive a complementary pair of target engagement poses for the first and second end effectors 140, each defined to engage opposing or symmetrically offset regions of the luggage unit. For example, the controller 160 can assign a first target position and first target orientation for the first end effector 140 to engage a first region (e.g., a long edge or lower corner of the luggage unit), and a second target position and second target orientation for the second end effector 140 to engage a second region (e.g., an opposing or adjacent surface, or a handle region) such that the two engagement poses collectively span the center of volume and approximate the center of mass of the luggage unit.

In this variation, the controller 160 can generate a first engagement path for the first robotic arm 130 to maneuver the first end effector 140 toward the first target pose and a second engagement path for the second robotic arm 130 to maneuver the second end effector 140 toward the second target pose, wherein the first and second engagement paths are defined to avoid collisions between the two robotic arms 130 and between either robotic arm 130 and the luggage unit prior to engagement. The controller 160 can further generate a first retraction path and a second retraction path for the first and second robotic arms 130, respectively, such that the retraction paths remain parallel and non-intersecting during lifting or transfer of the luggage unit.

Accordingly, the controller 160 can coordinate simultaneous or near-simultaneous motion of the first and second robotic arms 130 to engage, lift, and transfer a single luggage unit while maintaining positional symmetry and balanced load distribution. Thus, the system 100 can prevent application of opposing forces that may tear or twist the luggage unit, increase the likelihood of end effector disengagement, and/or decrease stability throughout the retrieval and placement of the luggage unit.

In one variation, the pair of robotic arms 130 can be configured to sequentially manipulate a particular luggage unit. In particular, in this variation, the first robotic arm 130 can be configured to retrieve and transfer a luggage unit from the luggage carousel to an intermediate position for retrieval by the second robotic arm 130. The second robotic arm 130 can be configured to receive the luggage unit from the first robotic arm 130, at the intermediate position, and place the luggage unit within a luggage cart.

In this variation, the controller 160 can calculate a target engagement specification for the first end effector 140 of the first robotic arm 130 to engage the luggage unit and transfer the luggage unit to the second end effector 140 of the second robotic arm 130. For example, the target engagement specification can define: a first target position for the first end effector 140 to engage the luggage unit; a repositioning maneuver for execution by the first robotic arm 130 to locate the luggage unit in an intermediate position (e.g., via translation or rotation relative to the platform 110); and a second target position for the second end effector 140 to engage the luggage unit at the intermediate position.

### 14.2 Dual-Arm Coordination for Single Luggage Unit Manipulation

In one variation, as shown in FIGS. 8A-8D, the robotic system 102 includes a pair of robotic arms 130 configured to cooperate to simultaneously grasp and transfer a particular luggage unit (e.g., oversized, irregular, or deformable luggage units) during coordinated retrieval from the luggage carousel. In particular, the robotic system 102 can coordinate end effector 140 engagement across both robotic arms 130 to apply distributed forces to the luggage unit, thereby minimizing deformation and reducing the risk of slippage during retrieval and transfer.

In this variation, the controller 160 can implement methods and techniques described above to: select a luggage unit for autonomous retrieval from the luggage carousel by the robotic system 102; derive a target engagement specification defining a first target engagement pose for the first end effector 140 and a second target engagement pose for the second end effector 140 to engage the luggage unit; derive a first engagement path for the first robotic arm 130 to maneuver the first end effector 140 to locate the first end effector 140 in the first target engagement pose; and derive a second engagement path for the second robotic arm 130 to maneuver the second end effector 140 to locate the second end effector 140 in the second target engagement pose. The controller 160 can then: trigger each robotic arm 130 to maneuver along the engagement path to locate the end effector 140 in the target engagement pose; trigger each end effector 140 to engage the luggage unit according to the target engagement specification; and trigger each robotic arm 130 to extract the luggage unit from the luggage carousel.

In one example, the robotic system 102 includes: a first robotic arm 130 including a first end effector 140 with a first suction head and a first gripper; and a second robotic arm 130 including a second end effector 140 with a second suction head and a second gripper. In this example, the first robotic arm 130 can: maneuver the first end effector 140 to a first target position vertically offset above the luggage unit; maneuver the first end effector 140 to a first target orientation facing downward toward a top surface (i.e., an accessible surface) of the luggage unit; and lower the first end effector 140 downward toward the luggage unit. The controller 160 can then: trigger the first suction head to transiently retain the luggage unit on the first end effector 140; and/or actuate the first gripper to retract inward to apply a gripping force to the sides of the luggage unit. Additionally, the second robotic arm 130 can: maneuver the second end effector 140 to a second target position horizontally offset from the luggage unit and a second target orientation facing toward a side surface (i.e., an accessible surface) of the luggage unit; and horizontally maneuver the second end effector 140 toward the luggage unit. The controller 160 can then: trigger the second suction head to transiently retain the luggage unit to the second end effector 140; and/or actuate the second gripper to retract inward to apply a gripping force to the top and bottom surfaces of the luggage unit.

Then, in response to detecting engagement between the first end effector 140 and the luggage unit and in response to detecting engagement between the second end effector 140 and the luggage unit, the controller 160 can trigger the pair of robotic arms 130 to maneuver the end effectors 140 (and the luggage unit) along respective retraction paths to extract the luggage unit from the luggage carousel. In particular, each robotic arm 130 can maintain a target orientation and contact force relative to the luggage unit such that: both end effectors 140 engage complementary accessible surfaces; both robotic arms 130 apply coordinated lifting forces to simultaneously raise the luggage unit; and both robotic arms 130 maintain a stable pose throughout the transfer operation to maintain alignment and load distribution.

The controller 160 can then implement methods and techniques described above to: trigger the robotic arm 130 to maneuver the end effectors 140 (and the luggage unit) through the field of view of an optical sensor 150 (e.g., arranged on the platform 110, arranged within the luggage bay); trigger an optical sensor 150 to capture a series of images of the luggage unit as the luggage unit traverses through the field of view of the optical sensor 150; and derive a virtual luggage model of the luggage unit based on the series of images.

The controller 160 can then: derive a target storage pose (i.e., the delivery position and orientation) for the luggage unit within a luggage cart assigned to the luggage unit; and execute a delivery path to maneuver the end effectors 140 to position the luggage unit in the target storage pose. In particular, the controller 160 can implement methods and techniques described above to: access an image (e.g., a three-dimensional representation) of an interior volume of a target luggage cart assigned to the luggage unit; and, based on the virtual luggage model of the luggage unit and the image depicting the target luggage cart, derive a target storage pose for the luggage unit within the target luggage cart. The controller 160 can then: derive a first delivery path for the first robotic arm 130 to maneuver the first end effector 140 to locate the luggage unit in the target storage pose; derive a second delivery path for the second robotic arm 130 to maneuver the second end effector 140 to locate the luggage unit in the target storage pose; trigger the platform 110 to navigate to a position adjacent the target luggage cart assigned to the luggage unit; trigger the first robotic arm 130 to maneuver along the first delivery path; and trigger the second robotic arm 130 to maneuver along the second delivery path to locate the luggage unit in the target storage pose within the target luggage cart. Accordingly, the robotic system 102 can include a pair of robotic arms 130 configured to simultaneously engage, lift, and transfer irregular, oversized, or unstable luggage units.

Furthermore, the robotic system 102 can include the pair of robotic arms 130 configured to implement methods and techniques described above to: retrieve luggage units from luggage carts arranged in the autonomous loading zone (e.g., from an incoming aircraft) and load these luggage units onto the luggage carousel within the work zone (e.g., for dispersion to a luggage claim facility within an airport); retrieve luggage units from luggage carts arranged in an autonomous aircraft loading zone (e.g., proximal an outbound aircraft) and load these luggage units onto a section of an aircraft conveyor proximal the autonomous aircraft loading zone (e.g., for delivery to a stowage compartment of the outbound aircraft); and retrieve luggage units from aircraft conveyors (e.g., from an incoming aircraft); and to load these luggage units into luggage carts arranged in the autonomous aircraft loading zone (e.g., for delivery to the luggage carousel).

### 14.2.1 Variation: Sequential Dual-Arm Coordination on a Single Luggage Unit

In one variation, the robotic system 102 includes a pair of robotic arms 130 configured to cooperate to sequentially manipulate a particular luggage unit. In this variation, the controller 160 can implement methods and techniques described above to: select a luggage unit for autonomous retrieval from the luggage carousel by the robotic system 102; trigger the first robotic arm 130 to retrieve the luggage unit from the luggage carousel; and trigger the first robotic arm 130 to maneuver the luggage unit to an intermediate position for retrieval by the second robotic arm 130. More specifically, the controller 160 can trigger the first robotic arm 130 to maneuver the luggage unit to an intermediate position (i.e., a transfer position) laterally and/or vertically offset from the luggage carousel and within the reachable workspace of the second robotic arm 130. The controller 160 can then trigger the second robotic arm 130 to receive the luggage unit from the first robotic arm 130 (e.g., at a target engagement surface).

The controller 160 can then: derive a target storage pose for the luggage unit within a luggage cart; derive a delivery path for the second robotic arm 130 to maneuver the second end effector 140 to locate the luggage unit in the target storage pose; trigger the platform 110 to navigate to a position adjacent the target luggage cart assigned to the luggage unit; and trigger the second robotic arm 130 to maneuver along the delivery path to locate the luggage unit in the target storage pose within the target luggage cart. Thus, in this variation, the robotic system 102 can coordinate the retrieval and placement of luggage units across multiple robotic arms 130 to reduce cycle time and accommodate luggage units that require multiple grasp points during different phases of the transfer sequence.

### 14.3 Independent Dual-Arm Operation

In one variation, as shown in FIGS. 8B-8D, the robotic system 102 includes a pair of robotic arms 130 configured to simultaneously retrieve and transfer separate luggage units from the luggage carousel to the luggage cart. In this variation, the controller 160 can implement methods and techniques described above to: select a first luggage unit for autonomous retrieval from the luggage carousel by the first robotic arm 130; and trigger the first robotic arm 130 to retrieve the first luggage unit from the luggage carousel. The controller 160 can simultaneously: select a second luggage unit for autonomous retrieval from the luggage carousel by the second robotic arm 130; and trigger the second robotic arm 130 to retrieve the second luggage unit from the luggage carousel. The controller 160 can then: derive a first target storage pose for the first luggage unit within a luggage cart; derive a second target storage pose for the second luggage unit within the luggage cart (or another luggage cart); trigger the platform 110 to navigate to a position adjacent the target luggage cart; trigger the first robotic arm 130 to locate the first luggage unit in the first target storage pose; and trigger the second robotic arm 130 to locate the second luggage unit in the second target storage pose.

### 14.4 Mode Toggling

In one variation, the robotic system 102 can be configured to toggle between independent and cooperative manipulation modes to accommodate a range of luggage unit types, geometries, and real-time handling conditions during the luggage transfer cycle. In particular, the robotic system 102 can dynamically switch between independent operation—in which each robotic arm 130 autonomously retrieves and transfers a separate luggage unit—and cooperative operation—in which both robotic arms 130 engage and transfer a single luggage unit—responsive to conditions affecting engagement quality, retrieval success, or system throughput. For example, the controller 160 can detect a luggage unit and interpret one or more characteristics of the luggage unit (e.g., irregular shape, excessive weight, high deformability, unstable orientation) that are incompatible with reliable single-arm retrieval. The controller 160 can then trigger the robotic system 102 to transition from independent to cooperative mode to improve engagement stability and reduce failure risk.

In this variation, during a first time period, the controller 160 can: access a first image captured by an optical sensor 150 and depicting luggage units located on the luggage carousel during the first time period; and implement methods and techniques described above to detect a first set of luggage characteristics of a first luggage unit and derive a first target engagement specification for retrieving the first luggage unit. In particular, based on the first set of luggage characteristics, the controller 160 can derive a first target engagement specification that specifies manipulation of the first luggage unit via the first robotic arm 130 (i.e., single-arm manipulation). The controller 160 can then implement methods and techniques described above to trigger the robotic system 102 to execute the first target engagement specification to retrieve the first luggage unit from the luggage carousel.

The controller 160 can then, during a second time period: access a second image captured by the optical sensor 150 and depicting luggage units located on the luggage carousel during the second time period; and implement methods and techniques described above to detect a second set of luggage characteristics of a second luggage unit and derive a second target engagement specification for retrieving the second luggage unit. In particular, based on the second set of luggage characteristics, the controller 160 can derive a second target engagement specification that specifies manipulation of the second luggage unit via the first robotic arm 130 and the second robotic arm 130 (i.e., dual-arm manipulation). The controller 160 can then implement methods and techniques described above to trigger the robotic system 102 to execute the second target engagement specification to retrieve the second luggage unit from the luggage carousel.

In one example, the robotic system 102 initially operates in independent mode, wherein each robotic arm 130 is assigned to retrieve and transfer a separate luggage unit. In this example, the controller 160 detects a particular luggage unit entering the work zone (e.g., a large soft-sided duffel bag) and interprets a deformability score of the luggage unit. In response to the deformability score exceeding a threshold deformability score, the controller 160 can trigger the robotic system 102 to transition into cooperative mode. The robotic system 102 then implements methods and techniques described above to execute a coordinated retrieval and transfer operation for the luggage unit (i.e., according to a dual-arm engagement specification).

In another example, the robotic system 102 initially operates in cooperative mode, wherein both robotic arms 130 are coordinated to retrieve and transfer a single luggage unit. In this example, the controller 160 detects two luggage units entering the work zone (e.g., two small hard-sided suitcases) and interprets a dimension (e.g., volume) and a deformability score for each luggage unit. In response to the dimensions falling below a threshold dimension and the deformability scores falling below the threshold deformability score (i.e., indicating sufficient structural integrity for single-arm handling), the robotic system 102 transitions into independent mode. The controller 160 then implements methods and techniques described above to assign each robotic arm 130 to a separate luggage unit and execute respective retrieval and transfer operations in parallel.

### 14.4.1 Mode Toggling: Engagement Failure

In one variation, the robotic system 102 can: attempt retrieval of a luggage unit via the first robotic arm 130 operating in independent mode; in response to detecting failed engagement between the first end effector 140 and the luggage unit (e.g., detecting a drop in the suction force and/or gripping force), transition to cooperative mode; and reattempt retrieval of the luggage unit via the pair of robotic arms 130 (e.g., during a successive revolution of the luggage unit on the luggage carousel). In this variation, in response to detecting failed engagement between the first end effector 140 and the luggage unit, the robotic system 102 can: implement methods and techniques described above to derive a new target engagement specification for retrieval of the luggage unit by the pair of robotic arms 130; and then load and execute this new target engagement specification to reattempt autonomous extraction of the luggage unit from the luggage carousel with the pair of robotic arms 130 operating in cooperative mode.

Accordingly, the robotic system 102 can implement on-demand (e.g., near real-time) toggling between cooperative and independent manipulation modes based on: detected engagement failures; confidence scores associated with prior engagement attempts for similar luggage unit types; operational conditions (e.g., platform 110 congestion, cart loading order); and/or performance indicators derived from the current retrieval operation (e.g., elapsed retrieval duration, end effector 140 slippage, or force variance outside nominal bounds).

### 15. Single Conveyor+Multiple Dual-Arm Robotic Systems

In one variation, as shown in FIG. 8A, the system includes: a conveyor 180 extending along a luggage carousel and adjacent luggage carts; a first robotic system 102 including a pair of robotic arms 130 arranged on a first platform 110; and a second robotic system 102 including a second pair of robotic arms 130 arranged on a second platform 110. In this variation, each robotic system 102 traverses a distinct section of the conveyor 180 (i.e., a non-overlapping portion of the conveyor 180 path) to retrieve luggage units from the luggage carousel and deliver the luggage units to assigned luggage carts. Each robotic system 102 can implement methods and techniques described above to: operate independently to increase throughput; cooperate to retrieve a single luggage unit; and toggle between independent and cooperative manipulation modes based on real-time handling conditions. In this variation, each robotic system 102 can service different locations along the luggage carousel and deliver luggage units to a broader range of cart assignments, thereby reducing retrieval latency and improving spatial coverage across the autonomous loading zone.

### 16. Multiple Conveyors

In one variation, as shown in FIGS. 8B and 8C, the system includes: a set of two or more conveyors 180 arranged along different sections of the luggage carousel or across parallel loading zones; and a corresponding set of robotic systems 100, wherein each conveyor 180 supports one or more robotic systems 100 configured for luggage retrieval and transfer. Each robotic system 102 can include a pair of robotic arms 130 and be traversed by a respective conveyor 180 to retrieve luggage units from the luggage carousel and deliver the luggage units to assigned luggage carts located adjacent the conveyor 180 (e.g., independently, in sequence, or in tandem). By distributing robotic systems 100 across multiple conveyors, the system can increase coverage across the luggage carousel, improve spatial access to luggage carts, and maintain high throughput under variable load conditions. In particular, in this variation, the system can reduce bottlenecks, minimize travel distance for each robotic system 102, and support redundant or parallel operation in high-traffic zones within the luggage bay.

### 17. Mobile Conveyor

In one variation, the system includes a mobile conveyor configured to support dynamic repositioning of the robotic system 102 between distinct zones within the airport luggage bay (e.g., from a luggage carousel area to an aircraft loading zone). For example, the mobile conveyor can include a set of wheels coupled to a conveyor 180 frame. In this variation, the mobile conveyor can maneuver to a position proximal the luggage carousel for the robotic system 102 to retrieve and load luggage units into luggage carts. The mobile conveyor can then maneuver to a new position adjacent an outbound aircraft to support retrieval of luggage units from the carts and loading onto an aircraft conveyor. In this variation, the mobile conveyor supports flexible deployment of robotic systems 100 across spatially separated transfer zones, thereby reducing idle time, minimizing infrastructure duplication, and improving operational responsiveness within the airport luggage bay.

### 18. Variation: Distal Linear Actuator for End Effector Extension

In one variation, each robotic arm 130 can include a linear actuator arranged between a distal end of the robotic arm 130 and the corresponding end effector 140. The linear actuator can define an additional translational degree of freedom orthogonal to the jointed axes of the robotic arm 130, thereby extending the reach of the end effector 140 without requiring the full arm to extend or reposition. In particular, the linear actuator can be configured to: extend the end effector 140 outward relative to the distal joint of the robotic arm 130 during luggage retrieval or placement; retract the end effector 140 toward the distal joint to stow the end effector 140 within the robotic arm 130; and maintain a straight or minimally angled configuration of the main segments of the robotic arm 130 while delivering translational movement at the end effector 140.

In this variation, the robotic system 102 can implement the linear actuator to: reduce the torque experienced at upstream joints of the robotic arm 130 by shortening the effective moment arm during luggage engagement; execute precise end effector placement without gross articulation of the robotic arm 130; and increase clearance between the robotic arm 130 and adjacent structural features (e.g., luggage cart walls, carousel edge) during complex maneuvers. Thus, the linear actuator can enhance maneuverability, reduce mechanical stress on the robotic arm 130 structure, and expand the set of reachable poses within confined or crowded environments typical of airport luggage bays.

In this variation, the robotic system 102 can implement methods and techniques described above to: retrieve a luggage unit located beyond the nominal reach envelope of the robotic arm 130; or deliver a luggage unit into a recessed region of a luggage cart or aircraft conveyor without requiring full articulation of the proximal arm joints. In particular, the controller 160 can: trigger the linear actuator to extend the end effector 140 outward from the robotic arm 130 to engage the luggage unit without requiring full articulation of the arm segments; and trigger the linear actuator to retract the end effector 140 following engagement to reduce the moment arm and improve lifting stability. Accordingly, the controller 160 can trigger the linear actuator to extend or retract the end effector 140 to increase mobility by introducing an additional translational degree of freedom at the distal end of each robotic arm 130, thereby reducing spatial constraints during manipulation and improving engagement accuracy in confined or obstructed environments.

The systems and methods described herein can be embodied and/or implemented at least in part as a machine configured to receive a computer-readable medium storing computer-readable instructions. The instructions can be executed by computer-executable components integrated with the application, applet, host, server, network, website, communication service, communication interface, hardware/firmware/software elements of a user computer or mobile device, wristband, smartphone, or any suitable combination thereof. Other systems and methods of the embodiment can be embodied and/or implemented at least in part as a machine configured to receive a computer-readable medium storing computer-readable instructions. The instructions can be executed by computer-executable components integrated by computer-executable components integrated with apparatuses and networks of the type described above. The computer-readable medium can be stored on any suitable computer readable media such as RAMs, ROMs, flash memory, EEPROMs, optical devices (CD or DVD), hard drives, floppy drives, or any suitable device. The computer-executable component can be a processor, but any suitable dedicated hardware device can (alternatively or additionally) execute the instructions.

As a person skilled in the art will recognize from the previous detailed description and from the figures and claims, modifications and changes can be made to the embodiments of the invention without departing from the scope of this invention as defined in the following claims.

I claim:

1. A system comprising:
a platform configured to navigate along an autonomous work zone located within an airport luggage bay between a luggage carousel conveying luggage units and a luggage cart transiently storing luggage units;
a first robotic arm:
arranged on the platform; and
comprising a first end effector configured to selectively retain luggage units;
a sensor suite defining a field of view intersecting the luggage carousel; and
a controller configured to:
access a first image captured by the sensor suite and depicting luggage units located on the luggage carousel;
select a first luggage unit, detected in the first image, for retrieval from the luggage carousel, the first luggage unit exhibiting a first set of luggage characteristics;
derive a first target engagement specification for the first robotic arm to engage the first luggage unit based on the first set of luggage characteristics;
trigger the first robotic arm to locate the first end effector in a first target engagement pose defined in the first target engagement specification;
trigger the first end effector to engage the first luggage unit according to the first target engagement specification;
trigger the first robotic arm to withdraw the first luggage unit from the luggage carousel; and
trigger the first robotic arm to locate the first luggage unit in a first
target storage pose within the luggage cart.

2. The system of claim 1:
wherein the platform:
comprises an autonomous mobile base:
configured to autonomously navigate along the autonomous work zone; and
comprising:
a set of drive motors configured to drive the autonomous mobile base; and
a set of depth sensors configured to detect objects proximal the platform; and
is weighted to counterbalance a load applied by the first robotic arm when extended from the platform while retaining the first luggage unit;
wherein the first robotic arm:
comprises a cobot arm;
is configured to:
extend from the platform in a first direction to locate the first end effector proximal the luggage carousel;
extend from the platform in a second direction, different from the first direction, to locate the first end effector proximal the luggage cart;
operate at a maximum velocity less than a velocity threshold defined for operation proximal a manual work zone; and
retain luggage units exhibiting masses less than a luggage mass threshold; and
wherein the sensor suite comprises:
a first optical sensor arranged on the platform and configured to:
capture the first image depicting luggage units located on the luggage carousel; and
capture a second image depicting an unoccupied volume of the luggage cart; and
a second optical sensor arranged within the airport luggage bay and configured to capture a third image depicting luggage units located on the luggage carousel.

3. The system of claim 1:
wherein the platform comprises an autonomous mobile base configured to navigate to the luggage carousel during a first time period;
wherein the first robotic arm is configured to:
retrieve the first luggage unit from the luggage carousel via the first end effector; and
stow the first luggage unit in the first target storage pose within the luggage cart during the first time period;
wherein the platform is further configured to navigate along a tarmac, located at an airport, to the luggage cart when the luggage cart is located on the tarmac proximal an aircraft during a second time period succeeding the second time period; and
wherein the first robotic arm is configured to:
locate the first end effector in a second target engagement pose for retrieving a second luggage unit from the luggage cart located on the tarmac proximal the aircraft;
engage the second luggage unit via the first end effector;
withdraw the second luggage unit from the luggage cart; and
position the second luggage unit in a target delivery pose on an aircraft conveyor configured to convey luggage units into the aircraft.

4. The system of claim 3:
further comprising a tray arranged on the platform; and
wherein the first robotic arm is configured to:
during the second time period:
engage the second luggage unit, via the first end effector, at a first engagement position on the second luggage unit when the second luggage unit is located within the luggage cart;
maneuver the second luggage unit to the tray while the second luggage unit is retained by the first end effector at the first engagement position;
disengage the first end effector to position the second luggage unit on the tray;
engage the second luggage unit, via the first end effector, at a second engagement position, different from the first engagement position, on the second luggage unit; and
maneuver the second luggage unit to a target delivery pose on the aircraft conveyor while the second luggage unit is retained by the first end effector at the second engagement position.

5. The system of claim 1, wherein the controller is configured to:
detect a second luggage unit, depicted in the first image, exhibiting a second set of luggage characteristics and arranged on the luggage carousel at a second orientation;
calculate a confidence score for successful retrieval of the second luggage unit by the first robotic arm based on the second set of luggage characteristics and the second orientation; and
in response to the confidence score falling below a threshold score:
generate an alert comprising:
a region of the first image depicting the second luggage unit; and
a prompt to manually retrieve the second luggage unit from the luggage carousel proximal a manual loading zone adjacent the autonomous work zone; and
transmitting the alert to a display located within the airport luggage bay.

6. The system of claim 1:
further comprising a second robotic arm:
arranged on the platform; and
comprising a second end effector configured to selectively retain luggage units; and
herein the controller is configured to:
derive the first target engagement specification, for retrieving the first luggage unit, specifying manipulation of the first luggage unit via the first robotic arm based on the first set of luggage characteristics;
access a second image captured by the sensor suite and depicting luggage units located on the luggage carousel;
select a second luggage unit, detected in the second image, for retrieval from the luggage carousel, the second luggage unit exhibiting a second set of luggage characteristics;
derive a second target engagement specification, for retrieving the second luggage unit, specifying manipulation of the second luggage unit via the first robotic arm and the second robotic arm based on the second set of luggage characteristics;
trigger the first robotic arm to locate the first end effector in a second target engagement pose defined in the second target engagement specification;
trigger the second robotic arm to locate the second end effector in a third target engagement pose defined in the second target engagement specification;
trigger the first end effector and the second end effector to engage the second luggage unit according to the second target engagement specification;
trigger the first robotic arm and the second robotic arm to withdraw the second luggage unit from the luggage carousel; and
trigger the first robotic arm and the second robotic arm to locate the second luggage unit in a second target storage pose within the luggage cart.

7. The system of claim 6, wherein the controller is configured to:
generate a first embedding encoding the first set of luggage characteristics of the first luggage unit;
access an engagement specification database containing a population of historical embeddings encoding luggage characteristics of luggage units and labeled with target engagement specifications associated with successful retrieval of luggage units;
identify a first historical embedding, in the population of historical embeddings, the first historical embedding:
proximal the first embedding; and
labeled with the first target engagement specification that specifies luggage manipulation via the first robotic arm;
generate a second embedding encoding the second set of luggage characteristics of the second luggage unit; and
identify a second historical embedding, in the population of historical embeddings, the second historical embedding:
proximal the second embedding; and
labeled with the second target engagement specification that specifies luggage manipulation via the first robotic arm and the second robotic arm.

8. The system of claim 1:
wherein the sensor suite comprises an optical sensor arranged within the airport luggage bay and defines a field of view intersecting the luggage carousel and the autonomous work zone; and
wherein the controller is configured to:
detect an initial position of the first luggage unit on the luggage carousel at an initial time based on the first image;
predict a first position of the first luggage unit on the luggage carousel at a first time, succeeding the initial time, based on:
the initial position of the first luggage unit;
a difference between the initial time and the first time; and
a velocity of the luggage carousel;
derive the first target engagement specification for the first robotic arm to engage the first luggage unit at the first position on the luggage carousel at the first time; and
trigger the platform to navigate along the autonomous work zone to align the first end effector to the first position of the first luggage unit at the first time based on the first target engagement pose.

9. The system of claim 8:
wherein the sensor suite comprises an optical sensor defining the field of view further intersecting the luggage cart; and
wherein the controller is configured to:
detect the first luggage unit located on the luggage carousel in the first image;
detect an unoccupied volume within the luggage cart in the first image;
based on the first image:
estimate a first dimension of the first luggage unit; and
select a first unoccupied subvolume, within the unoccupied volume within the luggage cart, characterized by a second dimension greater than the first dimension of the first luggage unit; and
define the first target storage pose, for the first luggage unit within the luggage cart, that intersects the first unoccupied subvolume within the luggage cart.

10. The system of claim 1:
wherein the sensor suite comprises an optical sensor arranged on the platform; and
wherein the controller is configured to:
detect the first luggage unit located at a first position on the luggage carousel at a first time based on the first image;
access a second image captured by the optical sensor;
detect the first luggage unit located at a second position on the luggage carousel at a second time based on the second image;
estimate a velocity of the first luggage unit on the luggage carousel based on:
the first position of the first luggage unit at the first time;
the second position of the first luggage unit at the second time; and
a difference between the first time and the second time;
in response to detecting the first luggage unit entering the autonomous work zone, trigger the platform to navigate along the autonomous work zone at the velocity to collocate the first robotic arm with the first luggage unit; and
trigger the first end effector to engage the first luggage unit according to the first target engagement specification while the first robotic arm is collocated with the first luggage unit.

11. The system of claim 1:
wherein the sensor suite comprises an optical sensor:
arranged on the platform; and
defining the field of view intersecting a path of the first end effector between the luggage carousel and the luggage cart;
wherein the first robotic arm is configured to:
retract from the luggage carousel to withdraw the first luggage unit, retained by the first end effector, from the luggage carousel; and
traverse the first luggage unit through the field of view of the optical sensor; and
wherein the controller is configured to:
access a series of images captured by the optical sensor during traversal of the first luggage unit through the field of view of the optical sensor;
compile the series of images depicting the first luggage unit into a first virtual luggage model representing three-dimensional surfaces of the first luggage unit;
estimate a first dimension of the first luggage unit based on the first virtual luggage model;
detect an unoccupied volume within the luggage cart in the first image;
select a first unoccupied subvolume, within the unoccupied volume within the luggage cart, characterized by a second dimension greater than the first dimension of the first luggage unit; and
define the first target storage pose, for the first luggage unit within the luggage cart, that intersects the first unoccupied subvolume within the luggage cart.

12. The system of claim 1:
wherein the sensor suite comprises an optical sensor defining the field of view intersecting the luggage carousel and the luggage cart; and
wherein the controller is configured to:
access the first image depicting the first luggage unit located on the luggage carousel and unoccupied volumes within the luggage cart;
generate a first embedding encoding the first set of luggage characteristics of the first luggage unit;
access a luggage model database containing a population of historical embeddings encoding luggage characteristics of luggage units;
identify a first historical embedding, in the population of historical embeddings, characterized by a shortest distance to the first embedding;
extract a first virtual luggage model, encoded in the first historical embedding, representing three-dimensional surfaces and dimensions of a previously-manipulated luggage unit resembling the first luggage unit;
estimate a first dimension of the first luggage unit based on the first virtual luggage model;
detect an unoccupied volume within the luggage cart in the first image;
select a first unoccupied subvolume, within the unoccupied volume within the luggage cart, characterized by a second dimension greater than the first dimension of the first luggage unit; and
define the first target storage pose, for the first luggage unit within the luggage cart, that intersects the first unoccupied subvolume within the luggage cart.

13. The system of claim 1:
further comprising a tray:
arranged on the platform; and
configured to transiently store luggage units; and
wherein the controller is configured to:
during a first time period:
in response to detecting a first location of the luggage cart, assigned to the first luggage unit, outside of the airport luggage bay:
trigger the first robotic arm to maneuver the first luggage unit, retained by the first end effector, over the tray; and
trigger the first end effector to release the first luggage unit onto the tray;
access a second image captured by the sensor suite and depicting luggage units arranged on the luggage carousel;
select a second luggage unit, detected in the second image, for retrieval from the luggage carousel;
derive a second target engagement specification for the first robotic arm to engage the second luggage unit based on a second set of luggage characteristics of the second luggage unit;
trigger the first robotic arm to locate the first end effector in a second target engagement pose defined in the second target engagement specification;
trigger the first end effector to engage the second luggage unit according to the second target engagement specification;
trigger the first robotic arm to withdraw the second luggage unit from the luggage carousel; and
trigger the first robotic arm to locate the second luggage unit in a second target storage pose within a second luggage cart arranged in the airport luggage bay; and
during a second time period succeeding the first time period:
in response to detecting a second location of the luggage cart, assigned to the first luggage unit, within the airport luggage bay:
trigger the platform to navigate along the autonomous work zone to align the first robotic arm to the luggage cart;
trigger the first robotic arm to retrieve the first luggage unit from the tray via the first end effector; and
trigger the first robotic arm to locate the first luggage unit in the first target storage pose within the luggage cart.

14. The system of claim 1:
further comprising a tray:
arranged on the platform; and
configured to transiently store luggage units; and
wherein the controller is configured to:
detect assignment of the first luggage unit to the luggage cart;
detect a second luggage unit, depicted in the first image, assigned to the luggage cart;
in response to assignment of the first luggage unit to the luggage cart and in response to assignment of the second luggage unit to the luggage cart, trigger the first robotic arm to locate the first luggage unit on the tray;
derive a second target engagement specification for the first robotic arm to engage the second luggage unit based on a second set of luggage characteristics of the second luggage unit;
trigger the first robotic arm to locate the first end effector in a second target engagement pose defined in the second target engagement specification;
trigger the first end effector to engage the second luggage unit according to the second target engagement specification;
trigger the first robotic arm to withdraw the second luggage unit from the luggage carousel;
trigger the first robotic arm to locate the second luggage unit in a second target storage pose within the luggage cart; and
trigger the first robotic arm to relocate the first luggage unit from the tray to the first target storage pose within the luggage cart.

15. The system of claim 1:
further comprising a conveyor:
interposed between the luggage carousel and the luggage cart; and
extending along the autonomous work zone;
wherein the platform is:
mounted to the conveyor; and
configured to navigate along the conveyor;
wherein the sensor suite comprises an optical sensor arranged on the platform; and
wherein the controller is configured to:
access the first image depicting the first luggage unit located on the luggage carousel proximal the platform;
in response to the first image depicting the first luggage unit entering the autonomous work zone, trigger the conveyor to traverse the platform to collocate the first robotic arm with the first luggage unit; and
trigger the conveyor to traverse the platform to align the first luggage unit, retained by the first end effector, to the first target storage pose.

16. A system comprising:
a platform configured to:
navigate between a luggage carousel and a set of luggage carts, located adjacent the luggage carousel within an airport luggage bay, at an airport; and
navigate between an aircraft conveyor, configured to convey luggage units into an aircraft, and the set of luggage carts located adjacent the aircraft conveyor on a tarmac at the airport;
a robotic arm arranged on the platform and configured to:
transfer luggage units from the luggage carousel to the set of luggage carts located within the airport luggage bay; and
transfer luggage units from the set of luggage carts, located on the tarmac, to the aircraft conveyor; and
a controller configured to:
detect a first set of luggage characteristics and a first orientation of a luggage unit located on the luggage carousel;
derive a first target engagement specification for retrieving the luggage unit from the luggage carousel based on the first set of luggage characteristics and the first orientation of the luggage unit;
trigger the platform to locate the robotic arm proximal the luggage unit on the luggage carousel;
trigger the robotic arm to withdraw the luggage unit from the luggage carousel according to the first target engagement specification; and
trigger the robotic arm to locate the luggage unit in a target storage pose within a luggage cart located within the airport luggage bay.

17. The system of claim 16, wherein the controller is further configured to:
trigger the platform to navigate along the tarmac to locate the robotic arm proximal the luggage cart;
detect a second set of luggage characteristics and a second orientation of the luggage unit located in the luggage cart;
derive a second target engagement specification for retrieving the luggage unit from the luggage cart based on the second set of luggage characteristics and the second orientation of the luggage unit;
trigger the robotic arm to withdraw the luggage unit from the luggage cart according to the second target engagement specification; and
trigger the robotic arm to locate the luggage unit in a target delivery pose on the aircraft conveyor.

18. The system of claim 16:
wherein the robotic arm comprises an end effector comprising:
a gripper configured to:
retract inwardly toward a center of the end effector to grip the luggage unit; and
extend outwardly from the center of the end effector to release the luggage unit; and
wherein the controller is configured to:
detect an orientation of the luggage unit on the luggage carousel and a luggage type of the luggage unit;
derive the first target engagement specification, for retrieving the luggage unit from the luggage carousel, specifying:
a set of target engagement surfaces for gripping the luggage unit based on the orientation of the luggage unit on the luggage carousel; and
a target gripping force based on the luggage type; and
trigger the gripper to:
engage the luggage unit at the set of target engagement surfaces; and
retract inwardly to grip the luggage unit according to the target gripping force.

19. The system of claim 16:
further comprising an optical sensor defining a field of view intersecting the luggage carousel and the luggage cart; and
wherein the controller is configured to:
access an image, captured by the optical sensor, depicting the luggage unit located on the luggage carousel and unoccupied volumes within the luggage cart;
predict a first position of the luggage unit on the luggage carousel at a first time based on an initial position of the luggage unit detected in the image;
trigger the platform to locate the robotic arm proximal the first position of the luggage unit at the first time;
detect an unoccupied volume within the luggage cart, compatible with the first set of luggage characteristics of the luggage unit, based on the image; and
derive the target storage pose, intersecting the unoccupied volume, for stowing the luggage unit within the luggage cart.

20. A method comprising:
accessing an image captured by an optical sensor defining a field of view intersecting a luggage carousel located within an airport luggage bay, the image depicting luggage units located on the luggage carousel;
detecting a luggage unit in the image;
extracting a set of luggage characteristics of the luggage unit, selected for retrieval from the luggage carousel, based on the image;
deriving a target engagement specification for retrieval of the luggage unit from the luggage carousel via a robotic system based on the set of luggage characteristics;
autonomously navigating a platform of the robotic system to collocate a robotic arm, arranged on the platform, with the luggage unit;
maneuvering the robotic arm to locate an end effector, arranged on a distal end of the robotic arm, in a target engagement pose defined in the target engagement specification;
triggering the end effector to engage the luggage unit according to the target engagement specification;
retracting the robotic arm from the luggage carousel to withdraw the luggage unit from the luggage carousel;
maneuvering the robotic arm to locate the luggage unit in a target storage pose within a luggage cart located within the airport luggage bay; and
triggering the end effector to release the luggage unit in the luggage cart.
